(19) United States
(12) Patent Application Publication
(10) Pub. No.: US 2026/0330198 A1
(43) Pub. Date: Oct. 22, 2026

(54) SYSTEM

(71) Applicant: SoftBank Group Corp., Tokyo (JP)

(72) Inventor: Takehiko KATAYAMA, Tokyo (JP)

(73) Assignee: SoftBank Group Corp., Tokyo (JP)

(21) Appl. No.: 19/650,402

(22) Filed: Apr. 17, 2026

(30) Foreign Application Priority Data
Apr. 22, 2025 (JP) 2025-070238

(51) Int. Cl. G06N 3/0475; G06N 3/096

(52) U.S. Cl. CPC G06N 3/0475; G06N 3/096

(57) ABSTRACT

The present invention relates to a system that automatically and flexibly links and adjusts independent network systems, such as telephone, data, mobile, train control, passenger guidance, reservation, advertisement distribution, and facility monitoring, operated by a plurality of railway business operators and subsidiary companies and affiliated companies thereof, by an integrated gateway function using generative AI. By automatically collecting interface information and a service quality requirement of each network system, and generating and reconfiguring an optimal linkage path and QoS setting by AI, an adjustment operation conventionally performed manually or by adding hardware becomes unnecessary, and operational efficiency improvement of the entire group, service quality improvement, rapid new service deployment, and automation of failure response are realized.

### CROSS-REFERENCE TO RELATED APPLICATION

The present application claims priority to and incorporates by reference the entire contents of Japanese Patent Application No. 2025-070238 filed in Japan on Apr. 22, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

A problem to be solved by the present invention is that diverse networks and systems, such as telephone, data, mobile, and train control, which are independently constructed and operated by a plurality of railway business operators and subsidiary companies and affiliated companies thereof, are not linked to each other, and information sharing and service linkage between the respective business operators or between the subsidiary companies are extremely difficult, so that, for example, integration of passenger services, realization of MaaS services, operational efficiency improvement of the entire group, and creation of new businesses cannot be performed quickly and flexibly, a great deal of time and cost are incurred for linkage between systems, and maintenance and optimization of service quality are also difficult. Furthermore, since system linkage has conventionally been realized by manual analog adjustment or retrofitted hardware addition, problems such as operational burden, lack of flexibility, limitation of expandability, and delay in response when a failure occurs have also become apparent, and in order to solve these problems, it is necessary to automatically collect and analyze interface information and a service quality requirement of each network and system, and realize software-based integrated adjustment and linkage by an AI agent, thereby fundamentally solving the conventional problems and accelerating digital transformation of the entire railway business operator group.

### SUMMARY OF THE INVENTION

Means for solving the problem according to the present invention is to configure a system for integrally linking a group of independent network systems operated by a plurality of business operators or affiliated companies thereof, the system comprising: an information collection unit configured to automatically collect interface information and a service quality requirement of each network system; a linkage adjustment unit configured to automatically generate a linkage path between the respective network systems based on the collected interface information and service quality requirement, and determine an optimal service quality setting for each linkage path; and an AI control unit configured to flexibly and timely reconfigure the linkage path and the service quality setting in accordance with a prompt input or an additional requirement using generative AI, and automatically realize linkage between the respective network systems, wherein the AI control unit operates on a cloud environment, comprehensively determines a physical or logical connection state of each network system, a service quality requirement according to a usage scene, and a linkage requirement between the business operators or between the affiliated companies, and centrally and automatically realizes, by software, an adjustment operation conventionally performed manually or by adding hardware.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor indicated by reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), among others.

In the following embodiments, a RAM (Random Access Memory) indicated by reference numeral is a memory where information is temporarily stored and used as a work memory by the processor.

In the following embodiments, a storage indicated by reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) indicated by reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

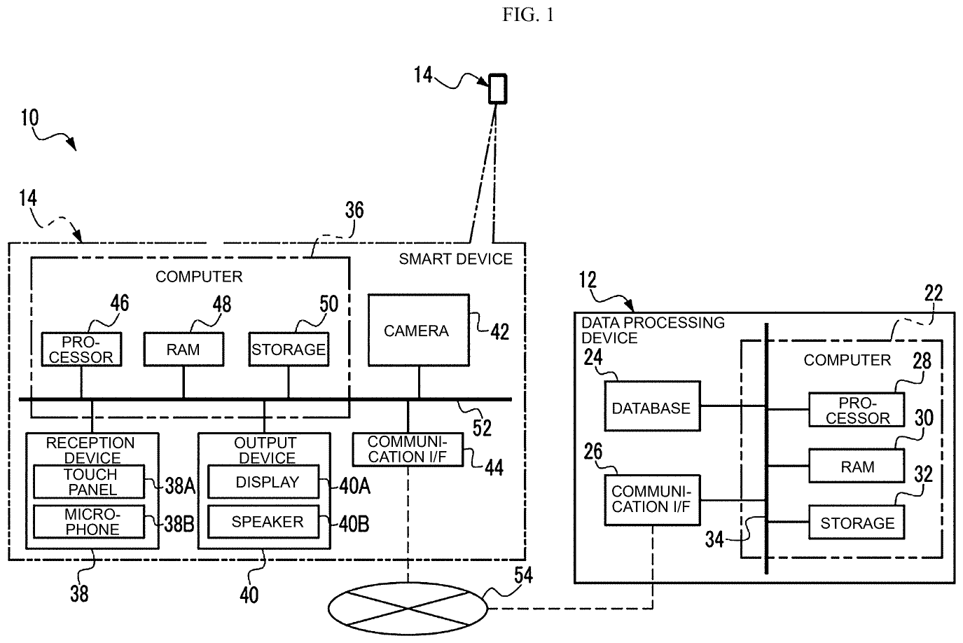

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, camera 42, and communication I/F 44 are also connected to the bus 52.

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A in the processor 46 sends data indicating user input accepted by the touch panel 38A and microphone 38B to the data processing device 12. In the data processing device 12, the specific processing unit 290 acquires data indicating user input.

The output device 40 comprises a display 40A and a speaker 40B, among others, and presents data to the user 20 by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

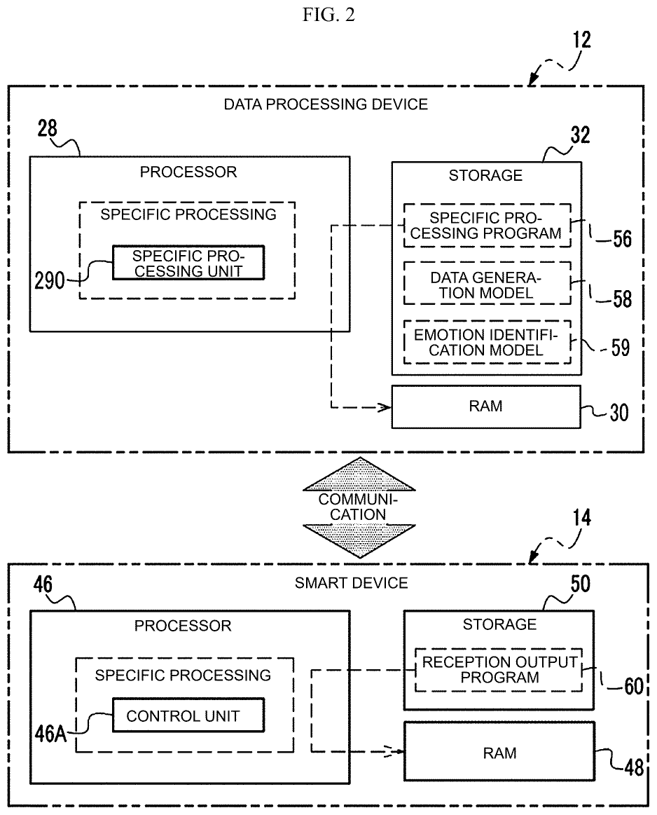

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart device 14, reception output processing is performed by the processor 46. The storage 50 stores a reception output program 60. The reception output program 60 is used in conjunction with the specific processing program 56 by the data processing system 10. The processor 46 reads the reception output program 60 from the storage 50 and executes it on the RAM 48. The reception output processing is realized by the processor 46 operating as a control unit 46A according to the reception output program 60 executed on the RAM 48. The smart device 14 may also have similar data generation models and emotion identification models as the data generation model 58 and emotion identification model 59, and perform the same processing as the specific processing unit 290 using these models. The reception output processing is realized by the processor 46 operating as the control unit 46A according to the reception output program 60 executed on the RAM 48.

Other devices besides the data processing device 12 may have the data generation model 58.

For example, a server device (e.g., a generation server) may have the data generation model 58.

In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example 1

The flow of the specific processing in Example 1 will be described. Each part of the system described below is realized by the data processing device 12 and the smart device 14. Additionally, the data processing device 12 is referred to as a “server,” and the smart device 14 is referred to as a “terminal.”

### Embodiment for Carrying Out the Present Invention

Embodiments for carrying out the present invention will be described more specifically and in detail. The system of the present invention automatically and flexibly links and adjusts various network systems operated by a railway business operator group and its subsidiaries and affiliated companies, that is, a telephone network, a data communication network, a mobile communication network, a train control network, a passenger guidance system, a reservation system, an advertisement distribution system, a facility monitoring system, and the like, by an integrated gateway function using generative AI. The system is composed of an information collection unit, a linkage adjustment unit, and an AI control unit, and these are mainly realized on a server side, but by distributing and arranging some functions also on a terminal side at a site, overall flexibility and responsiveness are improved. Specifically, the present system implements a hybrid artificial intelligence architecture combining a large language model and a graph neural network. The present system acquires topology information and a real-time traffic state of each network system as a multidimensional tensor. The present system supplies the acquired multidimensional tensor to an input layer of the graph neural network. The present graph neural network extracts spatial features of a connection relationship and a communication delay between nodes. The present system projects the extracted spatial feature vector into a latent space of the large language model. The present large language model integrally analyzes an operation policy described in a natural language and the spatial feature vector using an attention mechanism. The present system calculates an optimal routing path and a bandwidth allocation parameter based on this analysis result. The present system outputs the calculated parameter as structured data. The present system transmits the output structured data to a control interface of each gateway device. The present gateway device dynamically updates a packet transfer rule based on the received structured data. By this processing, the present system minimizes packet loss even when sudden communication traffic concentration occurs. The present system exhibits a technical effect of reducing a communication delay. The present system provides extremely high reliability in a mission-critical usage scene such as real-time data synchronization between a railway operation management system and a passenger guidance system. The present system cooperatively operates a main model with many weight parameters arranged on the server side and a lightweight model arranged on the site terminal side. The present system reflects a local traffic fluctuation pattern collected on the site terminal side in learning of the main model using a federated learning method. The present system continuously improves inference accuracy of the entire system without compressing a communication bandwidth. The present system eliminates manual setting by a human network administrator. The present system realizes communication efficiency at a level unreachable by a conventional method by a non-linear optimization operation in a high-dimensional space.

First, the information collection unit automatically collects interface information and a service quality (QoS) requirement through an agent program or an API installed in each network system. For example, from the telephone network, a line type (analog, digital, IP), a communication protocol in use, a bandwidth, a delay tolerance value, backup line information at the time of a failure, and the like are acquired. From the data communication network, an Ethernet standard in use, a VLAN configuration, a traffic volume, a packet loss rate, an encryption method, a firewall setting, and the like are acquired. From the mobile communication network, a wireless standard in use (LTE, 5G, etc.), base station information, a terminal authentication method, a communication area, a handover method, a QoS class identifier, and the like are acquired. From the train control network, a transmission method of a control signal, a redundant configuration, a real-time requirement, a failover procedure at the time of a failure, a security authentication method, and the like are acquired. From the passenger guidance system, a data update frequency, a real-time property, an external linkage API specification, the number of users, traffic information at a peak time, and the like are acquired. From the reservation system, a transaction processing capability, a database configuration, an external linkage interface, a recovery procedure at the time of a failure, a session management method, and the like are acquired. From the advertisement distribution system, a distribution data capacity, a distribution timing, targeting information, an external linkage API, distribution destination terminal information, and the like are acquired. From the facility monitoring system, a type of sensor data, a data collection cycle, an abnormality detection algorithm, a notification method, an external linkage API, and the like are acquired. Specifically, the present information collection unit converts a wide variety of interface information and service quality requirements acquired from each network system into a unified numerical vector processable by a machine learning model. The present information collection unit converts a categorical variable such as an analog line or a digital line into a multidimensional binary vector by one-hot encoding. The present information collection unit normalizes a continuous variable such as a bandwidth or a delay tolerance value to a range from zero to one using min-max scaling. The present information collection unit reconstructs time-series data such as a packet loss rate or a traffic volume as a two-dimensional time-series tensor by a sliding window process divided by a certain time window. The present information collection unit combines these preprocessed data to generate a single high-dimensional feature vector. The present information collection unit inputs the generated high-dimensional feature vector to an autoencoder for abnormality detection. The present autoencoder compresses the input high-dimensional feature vector into a low-dimensional latent variable. The present autoencoder restores the original high-dimensional feature vector from the compressed latent variable. The present information collection unit calculates a reconstruction error between the input vector and the restored vector. When the calculated reconstruction error exceeds a preset threshold value, the present information collection unit determines that an unknown failure or an abnormal traffic fluctuation has occurred in the network system. The present information collection unit transmits the data determined to be abnormal to the subsequent linkage adjustment unit together with a priority flag. By this processing, the present system discovers a sign of a minute abnormality in the network at an early stage. The present system exhibits a technical effect of preventing a large-scale communication failure. The present system is applied to a usage scene such as, for example, detecting a minute delay increase of a control signal in the train control network and immediately starting preparation for switching to a backup line. The present system is not limited to mere data collection. The present system dramatically improves a response speed and fault tolerance of the entire system by advanced data analysis at a collection stage.

Such information collection is performed at a site by a terminal (for example, a gateway device, an IoT device, a site terminal, a management PC, or the like) installed in each network system, and the collected information is aggregated in the information collection unit on the server side. For example, a specific operation is assumed in which an IoT terminal installed in a train depot periodically transmits a redundant configuration or a failure occurrence history of the train control network to the server, or a management terminal of the passenger guidance system automatically transmits the real-time number of users or traffic information to the server via an API. Specifically, the present site terminal autonomously executes primary processing on the collected raw data utilizing edge computing technology. The present site terminal extracts a local feature from a time-series waveform of sensor data or a traffic log using a built-in lightweight convolutional neural network. The present site terminal generates the extracted feature vector. The present site terminal transmits the generated feature vector to the information collection unit on the server side. The present site terminal significantly reduces consumption of a communication bandwidth compared to a conventional method of transmitting raw data as it is. The present site terminal receives, for example, a high-frequency time-series array obtained from a vibration sensor of a motor as input data in the IoT terminal of the train depot. The present site terminal applies a fast Fourier transform to this time-series array to convert it into spectrum data in a frequency domain. The present site terminal inputs the spectrum data to the convolutional neural network. The present convolutional neural network outputs an abnormality score indicating a degree of deviation from a normal spectrum pattern. The present site terminal transmits detailed log data to the server only when the abnormality score exceeds a specified threshold value. By this processing, the present system dramatically reduces a communication load of the entire network. The present system exhibits a technical effect of preventing depletion of processing resources on the server side. The present system becomes an essential configuration for ensuring scalability in a large-scale facility monitoring system to which tens of thousands of IoT devices are connected. Even when communication with the server is temporarily interrupted, the present site terminal autonomously continues abnormality detection using the built-in model. The present site terminal temporarily accumulates a detection result in a local storage. The present site terminal collectively transmits the accumulated data to the server after communication recovery. The present system constructs a robust information collection infrastructure having no single point of failure by such a distributed processing architecture.

The linkage adjustment unit automatically determines which systems are to be linked with each other through what path and method based on the detailed interface information and service quality requirement of each network system aggregated from the information collection unit, and generates a linkage path. For example, when linking a mobile network of a railway business operator A and a reservation system of a railway business operator B, API specifications, communication protocols, security requirements, and QoS requirements (for example, real-time reflection of reservation information, session maintenance, presence or absence of encrypted communication, etc.) of both are collated, and an optimal communication path and protocol conversion method are automatically selected. Furthermore, when simultaneous linkage is required among a plurality of network systems, for example, a complex linkage path such as transferring data to the advertisement distribution system at the same time while linking train operation information with the passenger guidance system in real time is also automatically designed. The linkage adjustment unit also supports various linkage patterns such as, for example, linking the train control network and the facility monitoring system to automatically transmit a control signal at the time of abnormality detection, or linking the passenger guidance system and the advertisement distribution system to distribute an advertisement in conjunction with a guidance display in a specific area when an event is held. Specifically, the present linkage adjustment unit dynamically searches for an optimal linkage path on a complex network topology using a deep reinforcement learning algorithm. The present linkage adjustment unit expresses node information and a link state of each network system as graph structure data. The present linkage adjustment unit inputs this graph structure data to a graph attention network. The present graph attention network dynamically calculates an importance degree between adjacent nodes and outputs a latent representation vector of each node. The present linkage adjustment unit uses the output latent representation vector as a state space of a reinforcement learning agent. The present reinforcement learning agent selects a node to be a next hop so as to maximize an action value function based on a Markov decision process. Input data to the present reinforcement learning agent includes a latent representation vector of a current node, a latent representation vector of a destination node, and a numerical vector of a required service quality requirement. Output data from the present reinforcement learning agent is an action probability distribution for a group of selectable adjacent nodes. The present linkage adjustment unit determines an optimal path according to this action probability distribution. The present linkage adjustment unit calculates a communication delay, a packet loss rate, and a bandwidth utilization rate of the determined path as an evaluation function. The present linkage adjustment unit feeds back a reward signal based on an evaluation result to the reinforcement learning agent. The present reinforcement learning agent updates a weight parameter of an internal neural network using temporal difference learning. By this processing, the present system reconstructs a path in real time and adaptively in response to a change in a congestion state or a failure occurrence situation of the network. The present system exhibits a technical effect of dramatically improving reachability and throughput of communication compared to a conventional method using a static routing table. The present system is extremely effective in a usage scene in which, for example, even when some communication base stations go down at the time of a disaster occurrence, an available detour path is instantly discovered and linkage between the train operation information and the passenger guidance system is maintained.

The processing of the linkage adjustment unit is mainly realized on the server side, but a protocol conversion module and a QoS control module can also be arranged on the site terminal side to execute an immediate response or a local optimization process at the site. For example, a site response is possible in which a gateway device at the site automatically switches to a backup line when a failure occurs in the train control network, or an advertisement distribution terminal automatically adjusts bandwidth allocation when the number of users rapidly increases. Specifically, the protocol conversion module and the QoS control module on the present site terminal side execute an inference process utilizing a hardware accelerator in order to realize ultra-low delay processing on an edge side. The present site terminal extracts header information and a part of a payload of a received packet as a tensor of a byte array. The present site terminal inputs the extracted byte array tensor to a quantized recurrent neural network. The present recurrent neural network infers an application type and a required real-time property of the communication flow from a sequence pattern of the packet. Output data from the present recurrent neural network is a class label indicating a priority of the communication flow and numerical data of a recommended bandwidth allocation amount. The present site terminal dynamically distributes the packet to a plurality of priority queues based on the output class label. The present site terminal adjusts a parameter of a token bucket algorithm in real time based on the recommended bandwidth allocation amount. By this processing, the present system enables an immediate response in units of milliseconds to a traffic fluctuation at the site without waiting for centralized control on the server side. The present system exhibits a technical effect of shortening an end-to-end communication delay to the utmost limit. The present system is applied to a usage scene in which, for example, when a packet requiring an extremely high real-time property such as an emergency stop signal is detected in the train control network, other non-priority traffic is temporarily blocked and immediately routed to a dedicated backup line. The present site terminal calculates an error between a local inference result and an actual measurement value of communication quality. The present site terminal periodically transmits error information to the server. The present system retrains the main model on the server side using this error information. The present system continuously improves inference accuracy on the edge side by distributing a weight parameter of the retrained model to the site terminal.

The AI control unit flexibly and timely reconfigures the linkage path and the service quality setting generated by the linkage adjustment unit in accordance with a prompt input or an additional requirement using generative AI. For example, dynamic reconfiguration is possible, such as temporarily raising QoS of a linkage path between the passenger guidance system and the train control system when an operation schedule is disrupted, or automatically incorporating a network system of a new subsidiary into an existing linkage path when the new subsidiary is added. The generative AI receives a prompt in a natural language (for example, “add a monitoring system of a construction-related subsidiary to data linkage newly”, “strengthen redundancy of a train control system”, “enhance a bandwidth of an advertisement distribution system when an event is held”, etc.), analyzes this, and automatically optimizes a linkage configuration and a QoS setting of the entire system. The AI control unit is mainly realized on the server side, but a lightweight AI agent can also be arranged on the terminal side to perform an immediate response or a local optimization process at the site in a distributed manner. For example, the AI agent can autonomously execute a determination at the site such that the site terminal “automatically switches to a backup path when a delay of a train control network exceeds a threshold value”. Specifically, the present AI control unit includes a large language model based on a transformer architecture specialized for natural language processing as a core. The present AI control unit converts a natural language prompt input from a system administrator into an integer token sequence using a subword tokenizer. The present AI control unit converts the token sequence into a multidimensional word embedding vector. The present AI control unit adds positional encoding to the word embedding vector and inputs it to an encoder layer of a transformer. Input data to the present AI control unit is, for example, a vector representation of a prompt “strengthen redundancy of a train control system” and an adjacency matrix tensor indicating a current network topology. The present large language model calculates a semantic relevance between an intention in the prompt and a current state of the network using a self-attention mechanism. Output data from the present large language model is structured JSON format data including a group of setting commands for a router to be changed, a numerical vector of a QoS parameter to be updated, and a node ID list to be applied. The present AI control unit inputs the output structured data to a syntax analyzer. The present syntax analyzer verifies validity of setting contents and consistency with a security policy. The present AI control unit automatically issues the group of setting commands that have passed the verification to a target network device. By this processing, the present system enables a network setting operation requiring advanced expertise to be executed only by an intuitive instruction in a natural language. The present system exhibits a technical effect of eliminating a human-caused failure due to a setting error and significantly reducing an operation management cost. The present system provides extremely high responsiveness in a usage scene in which, for example, in response to a rapid traffic increase accompanying a sudden event holding, an operation person in charge at the site instructs bandwidth enhancement by voice input, and the system immediately changes a network configuration. The lightweight AI agent arranged on the present terminal side retains an inference capability extracted from the large language model on the server side using a knowledge distillation method. The present lightweight AI agent continues an autonomous determination even when communication is disconnected.

In addition, the generative AI autonomously controls the entire system based on a prompt input or a learning result in all scenes such as a configuration change of a network system, addition of a new service, a response at the time of a failure occurrence, and operation optimization. For example, when a new subsidiary joins the railway business operator group and introduces a facility monitoring system, the information collection unit automatically acquires interface information and a QoS requirement of the new system, the linkage adjustment unit generates an optimal linkage path with an existing network system, and the AI control unit can immediately optimize a data transfer path and a QoS setting based on a prompt “aggregate all monitoring data to a head office system in real time”. Furthermore, for example, when the number of users of the passenger guidance system rapidly increases, the AI control unit can maintain service quality by automatically enhancing bandwidth allocation and raising QoS of the linkage path. Specifically, the present generative AI links with a database of a past configuration change history and a failure response manual using a retrieval-augmented generation technology. When detecting that a network system of a new subsidiary has been added, the present generative AI vectorizes text data of an interface specification of the new system provided from the information collection unit. The present generative AI searches for a similar past system integration case from a vector database using the vectorized text data as a query. The present generative AI combines the searched past case data, a current network state tensor, and a prompt from a system administrator to generate an expanded context. The present generative AI inputs the expanded context to the large language model. Output data from the present large language model is a step-by-step execution plan for safely integrating the new system into an existing network, a definition file of a necessary protocol conversion rule, and difference data of an optimal routing table. The present AI control unit updates a setting of each network device stepwise according to the output execution plan. The present AI control unit automatically executes a communication test after completion of each step, and confirms that there is no increase in packet loss or delay. By this processing, the present system dynamically utilizes past knowledge to derive an optimal integration procedure even for an unknown system configuration. The present system exhibits a technical effect of minimizing downtime accompanying system integration and ensuring continuity of a service. The present system realizes overwhelming business efficiency in a usage scene in which, for example, a unique facility monitoring system of an acquired company is connected to an integrated monitoring platform of the entire group in a short period of time, and a difference in data format is automatically absorbed. The present generative AI includes a reinforcement learning mechanism that receives success or failure of an execution result as a reward. The present generative AI continuously fine-tunes its own inference model to improve a success probability in a similar task in the future.

In addition, the generative AI can learn past operation data, a failure occurrence history, user behavior data, and the like, predict a future traffic increase or failure occurrence, and propose and automatically apply an optimal linkage path and QoS setting in advance. For example, a preventive operation is also possible in which the AI control unit automatically enhances a bandwidth of the passenger guidance system or the reservation system and strengthens a redundancy setting for a path with a high failure occurrence risk during a period when users rapidly increase, such as the year-end and New Year holidays or a long holiday. Specifically, the present generative AI includes a time-series prediction model combining a long short-term memory network and an autoregressive transformer. The present generative AI acquires multivariate time-series data including a traffic volume for past several years, a failure occurrence log, and calendar information (a public holiday, an event holding date, etc.) from a data accumulation unit. The present generative AI converts the acquired multivariate time-series data into a three-dimensional tensor composed of a feature vector for each time step. The present generative AI inputs this three-dimensional tensor to the time-series prediction model. The present time-series prediction model extracts periodicity and a trend from a past pattern, and calculates a traffic prediction value of each network node in a specific future time zone. Output data from the present time-series prediction model is a probability distribution of a predicted traffic volume at each node and an array of a risk score indicating a congestion occurrence probability. The present generative AI specifies a node for which the output risk score exceeds a predetermined threshold value. The present generative AI generates a change proposal of a preventive QoS setting for the specified node. The present generative AI outputs a setting script that predicts access concentration to the passenger guidance system at a peak time of the year-end and New Year holidays, for example, and expands an allocated bandwidth to the system to double in advance. The present AI control unit presents the output setting script on a dashboard of a system administrator and requests approval. When the approval is obtained, the present AI control unit automatically executes a setting change at a designated date and time. By this processing, the present system realizes a paradigm shift from reactive network management to data-driven proactive network management. The present system exhibits a technical effect of preventing a service stop due to a rapid traffic increase and improving a user experience. The present system calculates a prediction error as a loss function, and periodically updates a weight of the time-series prediction model using an error backpropagation method. The present system always keeps prediction accuracy in the latest state.

Furthermore, for example, when a construction-related subsidiary at a site introduces a new sensor device, the AI agent on the terminal side automatically recognizes an interface specification and a data collection cycle of the new device and reports them to the information collection unit on the server side, the linkage adjustment unit automatically generates a linkage path with an existing facility monitoring system, and the AI control unit can optimize a data transfer path and a QoS setting based on a prompt “notify a head office system immediately at the time of abnormality detection”. Specifically, the AI agent on the present terminal side executes dynamic profiling of a newly connected device based on a zero-trust network access architecture. When detecting that a new sensor device is physically or logically connected to a network, the present AI agent captures a payload and header information of an initial communication packet transmitted by the device. The present AI agent extracts a feature amount such as a type of a communication protocol, a packet size, a transmission interval, and a used port number from the captured packet data. The present AI agent converts the extracted feature amount into a multidimensional vector and inputs it to a pre-learned clustering algorithm. Output data from the present clustering algorithm is a classification label indicating an equipment category of the device and numerical data of an estimated data transmission cycle. The present AI agent transmits the output classification label and numerical data to the information collection unit on the server side through a secure encrypted communication channel. The linkage adjustment unit on the present server side automatically constructs an optimal virtual private network tunnel from the sensor device to the head office system based on the received device information. The present AI control unit collates a natural language analysis result based on a prompt input with path information of the constructed tunnel. The present AI control unit applies a rule for assigning a QoS tag of the highest priority to an alert packet at the time of abnormality detection to a group of intermediate routers on a path. By this processing, the present system completely eliminates a manual network setting operation in a dynamic site environment in which a wide variety of IoT devices are frequently added and deleted. The present system exhibits a technical effect of realizing secure device integration by plug and play. The present system provides extremely high flexibility in a usage scene in which, for example, a group of environmental sensors temporarily installed at a construction site is immediately linked to a monitoring platform of a head office to start real-time safety management.

As described above, the system of the present invention mainly realizes core functions of the information collection unit, the linkage adjustment unit, and the AI control unit on the server side, and adopts a configuration in which information acquisition from each network system, protocol conversion, and a local optimization process by a local AI agent are executed on the terminal side, whereby integrated linkage and adjustment of networks and systems of the entire group can be automatically and flexibly realized by utilizing generative AI. The generative AI autonomously controls the entire system based on a prompt input or a learning result in all scenes such as a configuration change of a network system, addition of a new service, a response at the time of a failure occurrence, and operation optimization, and thus becomes an indispensable element for realizing the present invention. Specifically, an architecture of the entire present system is constructed as a distributed machine learning infrastructure in which a cloud server group and an edge device group cooperatively operate. The present system operates a large language model having billions of parameters and a complex graph neural network on the server side, and is in charge of a global optimization calculation of the entire system. The present system operates a neural network dedicated to inference lightened by model quantization and pruning technologies on the terminal side, and is in charge of a local optimization process in units of milliseconds. The present system periodically synchronizes only a difference in weight parameter of a model between the server side and the terminal side using a federated learning protocol. The present system reflects a unique traffic characteristic of each site in a learning model of the entire system without transmitting confidential data or privacy information of the site to the server. By this processing, the present system achieves both protection of data privacy and performance improvement of a machine learning model at a high level. The present system exhibits a technical effect of continuously evolving inference accuracy of the entire system while minimizing consumption of a communication bandwidth. The present system quantifies uncertainty with respect to an inference result of the generative AI using a Bayesian neural network. The present system includes a mechanism that automatically shifts to a fail-safe mode and applies a safe default setting when a certainty degree of inference is low. The present system prevents a fatal network failure due to an erroneous determination by AI. The present system provides a technical breakthrough for introducing generative AI at a practical level in an area where extremely high safety is required, such as railway infrastructure. The present system is not a mere business efficiency improvement tool, but a next-generation computer technology that enables autonomous evolution of network infrastructure itself.

### System Configuration

The system according to the present embodiment includes an information collection unit, a linkage adjustment unit, an AI control unit, a protocol conversion unit, a QoS control unit, a site terminal linkage unit, a data accumulation unit, and a user interface unit. The information collection unit automatically collects interface information, a service quality requirement, a communication protocol, a bandwidth, a delay tolerance value, a redundant configuration, a failure occurrence history, the number of users, traffic information, a sensor data collection cycle, an external linkage API specification, an encryption method, a security authentication method, a transaction processing capability, a database configuration, peak traffic information, a distribution data capacity, a distribution timing, targeting information, an abnormality detection algorithm, a notification method, and the like from various network systems such as a telephone network, a data communication network, a mobile communication network, a train control network, a passenger guidance system, a reservation system, an advertisement distribution system, and an equipment monitoring system operated by a railway business operator and its subsidiaries and affiliated companies. For example, there are cases where an IoT terminal installed in a train depot periodically transmits the redundant configuration and the failure occurrence history of the train control network to a server, where a management terminal of the passenger guidance system automatically transmits the real-time number of users and traffic information to the server via an API, where a terminal of the advertisement distribution system transmits distribution destination terminal information and the distribution timing to the server, and where a terminal of the equipment monitoring system transmits the sensor data collection cycle and the abnormality detection algorithm to the server. Specifically, the information collection unit receives a huge amount of telemetry data asynchronously transmitted from tens of thousands of heterogeneous devices without loss using a distributed message queuing system. The information collection unit executes a data pipeline that converts the received data in various formats into a multidimensional tensor having a common schema. The information collection unit extracts, for example, an array of Boolean values indicating the redundant configuration of the train control network, a list of pairs of a timestamp and an error code indicating the failure occurrence history, and an integer value indicating the real-time number of users of the passenger guidance system. The information collection unit combines these extracted data as a feature vector representing each network node. The information collection unit reduces the dimension of the combined feature vector using a principal component analysis algorithm. The information collection unit expands the dimension-reduced vector on a memory as graph structure data together with an adjacency matrix indicating a connection relationship between nodes. Input data to the information collection unit is, for example, JSON format sensor data transmitted from the IoT terminal or an XML format traffic report transmitted from the management terminal via the API. Output data from the information collection unit is a normalized and structured graph tensor, which is used as a direct input to a machine learning model in the subsequent linkage adjustment unit and AI control unit. By this processing, the system converts siloed data generated from various system groups having different vendors and standards into a unified mathematical representation. The system exhibits a technical effect of providing a high-quality data infrastructure for a subsequent AI model to accurately learn a correlation of the entire system. The system serves as a foundation for the AI to identify a hidden causal relationship that is difficult for humans to discover, which is hidden between, for example, a fluctuation in the sensor data collection cycle of the equipment monitoring system and a decrease in the transaction processing capability of the reservation system.

The linkage adjustment unit automatically determines which systems are to be linked with each other through what path and method based on the detailed interface information and service quality requirement of each network system aggregated from the information collection unit, and generates a linkage path. For example, when linking a mobile network of a railway business operator A and a reservation system of a railway business operator B, API specifications, communication protocols, security requirements, and QoS requirements of both are collated, and an optimal communication path and protocol conversion method are automatically selected. Furthermore, it corresponds to various linkage patterns, such as a case of designing a complex linkage path that transfers data to the advertisement distribution system at the same time while linking train operation information with the passenger guidance system in real time, a case of automatically transmitting a control signal at the time of abnormality detection by linking the train control network and the equipment monitoring system, and a case of distributing an advertisement in conjunction with a guidance display in a specific area at the time of holding an event by linking the passenger guidance system and the advertisement distribution system. Specifically, the linkage adjustment unit calculates a Pareto-optimal routing topology that simultaneously satisfies a plurality of competing linkage requirements using a multi-agent reinforcement learning algorithm. The linkage adjustment unit receives the graph tensor output from the information collection unit as an input. The linkage adjustment unit models each network system as an independent learning agent. Each learning agent selects an action with minimization of communication delay and maximization of throughput of its own system as an objective function. The linkage adjustment unit formulates a scramble for a communication bandwidth between agents as a non-cooperative game based on game theory. The linkage adjustment unit updates a weight of a neural network of each agent so as to converge to a Nash equilibrium point. Input data to the linkage adjustment unit are a QoS requirement vector of each system, a current bandwidth utilization rate tensor, and a constraint matrix of a security policy. Output data from the linkage adjustment unit is an update matrix of a routing table including an identifier of an optimal virtual path for each data flow, an ID of a protocol conversion module to be applied, and a numerical value of a bandwidth to be allocated. The linkage adjustment unit transmits the output update matrix to a controller of a software-defined network, and dynamically rewrites a flow table of a physical switch. By this processing, the system globally optimizes resource allocation of the entire system instead of single path optimization. The system exhibits a technical effect of preventing a load from concentrating on a specific network and maximizing overall communication efficiency. The system realizes a use case of maximizing bandwidth utilization efficiency by dynamically allocating an empty bandwidth to advertisement data while prioritizing a packet of operation information, for example, in a case where real-time distribution of train operation information and transfer of large-capacity advertisement video data share the same physical line.

The AI control unit flexibly and timely reconfigures the linkage path and a service quality setting generated by the linkage adjustment unit in accordance with a prompt input or an additional requirement using generative AI. For example, dynamic reconfiguration and preventive operation are possible, such as a case of temporarily raising the QoS of the linkage path between the passenger guidance system and the train control system when an operation schedule is disrupted, a case of automatically incorporating the network system into an existing linkage path when a new subsidiary is added, a case of automatically enhancing bandwidth allocation and raising the QoS of the linkage path when the number of users of the passenger guidance system rapidly increases, and a case of enhancing the bandwidth of the passenger guidance system and the reservation system and strengthening a redundant setting for a path with a high risk of failure occurrence during a period when the number of users rapidly increases such as the year-end and New Year holidays and long holidays. Specific examples of a prompt sentence to be read by the generative AI include “add a monitoring system of a construction subsidiary to data linkage newly”, “strengthen redundancy of the train control system”, “enhance a bandwidth of the advertisement distribution system when an event is held”, “automatically expand a bandwidth when the number of users of the passenger guidance system exceeds a threshold”, “immediately notify a head office system when an abnormality is detected in the equipment monitoring system”, “automatically adjust a transaction processing capability of the reservation system in accordance with a peak time”, “automatically switch to a backup path when a delay of the train control network exceeds a threshold”, and “share distribution destination terminal information of the advertisement distribution system with the passenger guidance system in real time”. Specifically, the AI control unit implements an advanced inference engine integrating a prompt engineering technology and a retrieval-augmented generation pipeline. The AI control unit decomposes the input natural language prompt into slots such as “action”, “target system”, “condition”, and “constraint” using a semantic role labeling algorithm. The AI control unit extracts a similar context from a vector database storing a past operation history using the decomposed slot information as a query. The AI control unit dynamically constructs an input prompt for a large language model by combining the extracted context and a current network state tensor. Input data to the large language model is, for example, a text token sequence “automatically expand a bandwidth when the number of users of the passenger guidance system exceeds a threshold” and a numerical vector indicating a current bandwidth usage rate. Output data from the large language model is structured JSON data including a specific command line interface script to be executed, an IP address list of a router to be subjected to a setting change, and a predicted value of an expected QoS index after the change. The AI control unit pre-executes the output script in a sandbox environment, and verifies by simulation that a network loop or communication disconnection does not occur. The AI control unit applies only the successfully verified script to a production environment. By this processing, the system automatically generates a safe and accurate network control command from an ambiguous instruction in a natural language. The system exhibits a technical effect of dramatically reducing a burden on an operation manager and bringing downtime associated with a setting change close to zero. The system provides unparalleled operational efficiency in a use case where, for example, in response to a rapid increase in traffic during the year-end and New Year holidays, the system autonomously completes scale-out of a server and a setting change of a load balancer simply by the manager voice-inputting “automatically adjust a transaction processing capability of the reservation system in accordance with a peak time”.

When communication protocols are different between different network systems, the protocol conversion unit automatically executes various protocol conversion processes, such as converting an analog signal of the telephone network into an IP packet, converting an Ethernet frame of the data communication network into a wireless packet of the mobile communication network, converting a dedicated signal of the train control network into an API format of the passenger guidance system, and converting sensor data of the equipment monitoring system into a database format of the reservation system. Specifically, the protocol conversion unit executes an advanced data processing pipeline combining a deep packet inspection technology and a semantic conversion algorithm. The protocol conversion unit analyzes a payload of the received packet at a byte level, and extracts a semantic structure of data. The protocol conversion unit converts, for example, an analog audio signal received from the telephone network into pulse code modulation data using a digital signal processor. The protocol conversion unit encapsulates this pulse code modulation data into an IP packet of a real-time transport protocol. The protocol conversion unit parses sensor data in a unique binary format received from the equipment monitoring system using a predefined parser. The protocol conversion unit converts the parsed data into a dictionary object consisting of key-value pairs. The protocol conversion unit dynamically reconstructs this dictionary object into an SQL insert statement of a relational database or a JSON payload of a RESTful API requested by the reservation system. Input data to the protocol conversion unit is a raw byte array tensor based on a protocol specification of a transmission source system. Output data from the protocol conversion unit is a formatted data stream completely compliant with a protocol specification of a destination system. The protocol conversion unit holds a data type mapping table on a memory and executes a strict type check in order to prevent data loss or accuracy degradation occurring in the course of the conversion process. By this processing, the system completely eliminates a communication barrier between a legacy system and the latest cloud-native system. The system exhibits a technical effect of dramatically improving interoperability between systems. The system enables a use case of, for example, converting a signal of the train control network using a dedicated line from decades ago into data for push notification of the latest passenger guidance application for smartphones in real time, and instantly delivering delay information to passengers.

The QoS control unit executes communication bandwidth allocation, delay control, packet priority setting, automatic switching of a redundant path, traffic shaping, application of encrypted communication, automatic recovery at the time of failure occurrence, and the like in accordance with a service quality requirement required for each linkage path. For example, fine-grained QoS control is performed, such as enhancing a bandwidth at a peak time of the passenger guidance system, automatically switching to a backup path when a delay of the train control network exceeds a threshold, dynamically adjusting a bandwidth in accordance with a distribution timing of the advertisement distribution system, and making data transfer immediate by raising a priority at the time of abnormality detection in the equipment monitoring system. Specifically, the QoS control unit dynamically adjusts parameters of a token bucket algorithm and hierarchical priority queuing for traffic shaping in units of microseconds based on an inference result of a machine learning model. The QoS control unit extracts a 5-tuple including a source IP, a destination IP, a port number, and a protocol number from a packet header of each data flow. The QoS control unit inputs the extracted 5-tuple into a hash function, and generates a flow identifier. The QoS control unit calculates a moving average of a packet arrival rate and a delay time for each flow identifier, and generates a state vector. The QoS control unit inputs this state vector into a deep Q-network trained by reinforcement learning. Output data from the deep Q-network is numerical data indicating an optimal token replenishment rate, a bucket size, and a queue priority class for the flow. The QoS control unit directly writes the output numerical data into a hardware register of a network interface card, and executes packet transfer control at a hardware level. By this processing, the system eliminates overhead due to software processing, and realizes advanced QoS control at wire speed. The system exhibits a technical effect of guaranteeing a delay of mission-critical communication even in a network congestion state. The system plays a decisive role in protecting human life and infrastructure safety in a use case where, for example, when the equipment monitoring system detects a serious abnormality such as a fire, a queue with the highest priority is immediately allocated to a flow of the alert data, and all other background communications are temporarily bandwidth-limited, thereby causing the alert data to reach the head office system with a delay of milliseconds. Also in the application of encrypted communication, the QoS control unit dynamically changes the strength of an encryption algorithm in accordance with the importance of a packet, and optimizes a trade-off between security and processing delay.

The site terminal linkage unit links with a terminal, a gateway device, an IoT device, a management PC, and the like installed in each network system, and executes information collection at a site, protocol conversion, QoS control, site optimization processing by an AI agent, an immediate response at the time of failure occurrence, prompt input reception from the site, and the like. For example, various site linkages are realized, such as a site terminal automatically switching to a backup line when a failure occurs in the train control network, an advertisement distribution terminal automatically adjusting bandwidth allocation when the number of users rapidly increases, an equipment monitoring terminal automatically recognizing an interface specification and reporting it to a server when a new sensor device is added, and a site worker transmitting a prompt from a voice input or a tablet terminal to transmit a site requirement to the AI control unit. Specifically, the site terminal linkage unit deploys a containerized microservice architecture on an edge device, and realizes autonomous data processing at the site and asynchronous communication with the server. The site terminal linkage unit analyzes time-series data streamed from a sensor in real time using an inference engine incorporated in the gateway device at the site. Input data to the site terminal linkage unit is, for example, one-dimensional array data of a vibration sensor sampled at 100 hertz. The site terminal linkage unit inputs this one-dimensional array data into a one-dimensional convolutional neural network. Output data from the one-dimensional convolutional neural network is a floating-point number of an abnormality score indicating a degree of deviation from a normal state. When the abnormality score exceeds a threshold, the site terminal linkage unit immediately rewrites a local routing table, and executes a failover process of detouring a control signal to a backup line. The site terminal linkage unit receives a voice input from a tablet terminal possessed by a site worker. The site terminal linkage unit converts voice waveform data into a text prompt using a built-in voice recognition model. The site terminal linkage unit transmits the converted text prompt to the AI control unit on the server side. By this processing, the system enables an immediate response at the site without being affected by a communication delay to a cloud server or network disconnection. The system exhibits a technical effect of significantly reducing a traffic inflow amount to a core network by data filtering on an edge side. The system provides extremely high reliability in a use case where, for example, in a place where a communication environment in a tunnel is unstable, a site terminal autonomously detects an abnormality, and burst-transmits only a compressed alert log to the server at the moment communication is restored. The site terminal linkage unit has a function of receiving difference data of a weight parameter of a model periodically distributed from the server, and hot-updating the inference engine on the edge side without downtime.

The data accumulation unit accumulates interface information, a service quality requirement, a communication history, a failure occurrence history, traffic information, user behavior data, a prompt input history, an optimization result by AI, and the like collected from each network system in chronological order, and utilizes them as learning data for the generative AI. For example, data-driven operation optimization is realized, such as predicting future failure occurrence by learning a past failure occurrence pattern, optimizing bandwidth allocation at a peak time by analyzing user behavior data, grasping a tendency of a site requirement and generating an automation rule by analyzing a prompt input history, and reflecting an optimization result by AI in future decision-making by accumulating it. Specifically, the data accumulation unit adopts a hybrid data lake architecture combining a distributed relational database storing structured data and a vector database storing unstructured data and a high-dimensional vector. The data accumulation unit writes millions of telemetry data, communication logs, and failure events per second sent from the information collection unit to a time-series database at high speed using a timestamp as a key. The data accumulation unit converts text data of a natural language prompt input to the AI control unit and an output result of the AI corresponding thereto (a setting script and a routing change history) into a multidimensional dense vector using a text embedding model. The data accumulation unit indexes and stores the converted dense vector in the vector database. Input data to the data accumulation unit is, for example, a time-series array of a CPU usage rate of a network device and a character string of a prompt “expand a bandwidth”. Output data from the data accumulation unit is a vector group of past similar events related to a specific failure pattern, extracted for re-learning or retrieval-augmented generation of the generative AI. The data accumulation unit periodically applies a self-supervised learning algorithm to the accumulated huge amount of data. The data accumulation unit automatically acquires an unknown traffic fluctuation pattern hidden in the data or a feature representation serving as a sign of a failure. By this processing, the system constructs a knowledge base for continuously evolving the entire system, rather than a mere log repository. The system exhibits a technical effect of accumulating past experiences as a mathematical model and dramatically improving prediction accuracy and response speed for a future unknown failure. The system serves as a foundation for a use case of, for example, analyzing user behavior data and meteorological data for the past several years by multiplying them, predicting access concentration to the passenger guidance system under a specific weather condition in advance, and causing the AI control unit to propose preventive bandwidth expansion.

The user interface unit provides a GUI, a dashboard, a voice input interface, an application for a mobile terminal, and the like for a system manager and a site worker to perform system state monitoring, prompt input, confirmation/change of a linkage path and a QoS setting, a response instruction at the time of failure occurrence, confirmation of an optimization proposal by AI, history reference of the data accumulation unit, and the like. For example, various user interfaces are realized, such as a manager grasping a linkage status and a QoS setting of the entire network at a glance on a dashboard, a site worker inputting a prompt in a natural language from a tablet terminal, transmitting an immediate response instruction to the AI control unit by voice input at the time of failure occurrence, and a manager approving/rejecting an optimization proposal by AI. Specifically, the user interface unit is implemented as a web-based single-page application, and includes an advanced graphics rendering engine that visualizes a back-end system state in real time. The user interface unit applies a dimensionality reduction algorithm such as t-distributed stochastic neighbor embedding (t-SNE) or uniform manifold approximation and projection (UMAP) to multidimensional network traffic data acquired from the data accumulation unit. The user interface unit maps a high-dimensional traffic state on a screen as a two-dimensional or three-dimensional scatter plot. Input data to the user interface unit is a multidimensional tensor including a bandwidth usage rate, a delay, and a packet loss rate of each node. Output data from the user interface unit is an interactive dashboard screen that visually highlights an abnormal node deviating from a normal traffic cluster. When the system manager clicks a specific node on the screen, the user interface unit pop-up displays a detailed QoS setting and a past prompt input history related to the node. The user interface unit provides a chatbot interface incorporating a natural language processing model. The user interface unit receives an ambiguous question text such as “where is a current bottleneck?” from the manager. The user interface unit vectorizes this text, generates a specific node ID and a proposal text of a solution in linkage with the AI control unit, and displays them on the screen. By this processing, the system converts a state of a huge network infrastructure becoming complex into a format that can be intuitively understood in accordance with human cognitive ability. The system exhibits a technical effect of significantly shortening a cause investigation time at the time of failure occurrence and supporting quick decision-making. The system realizes a use case where, for example, a site worker wears smart glasses and performs maintenance work while overlay-displaying a current traffic volume of a router in front of the worker and an optimization proposal by AI in a field of view through an augmented reality (AR) interface.

As described above, the system according to the present embodiment includes the information collection unit, the linkage adjustment unit, the AI control unit, the protocol conversion unit, the QoS control unit, the site terminal linkage unit, the data accumulation unit, and the user interface unit, and automatically and flexibly realizes integrated linkage, adjustment, and optimization of the network and system of the entire railway business operator group by utilizing the generative AI while the respective units closely link with each other. Specifically, the system functions as an integrated computer architecture in which the above-described information collection unit, the linkage adjustment unit, the AI control unit, the protocol conversion unit, the QoS control unit, the site terminal linkage unit, the data accumulation unit, and the user interface unit are tightly coupled via a high-speed internal bus and a message broker. The system transmits and receives a multidimensional tensor and structured JSON data asynchronously and in a streaming format between the respective modules. The system places an inference capability of the generative AI at the core of orchestration of the entire system. The system autonomously searches for and applies an optimal system configuration to a non-linear and dynamic environmental change that cannot be handled by a conventional rule-based network management system. The system executes a series of processes from observation data of an input network state to output of an optimal control command end-to-end without human intervention. By this processing, the system raises utilization efficiency of communication resources to a mathematical limit in an extremely large-scale and mission-critical infrastructure called a railway business operator group. The system exhibits a technical effect of shortening a recovery time at the time of failure occurrence to the order of milliseconds and maximizing availability of the entire system. The system realizes a self-organizing network in which a network infrastructure itself adapts to an environment and grows by continuous self-evolution of a machine learning model, not limited to mere automation of an existing business. The system provides ultimate scalability and flexibility in which, for example, even when a new communication standard or an unknown IoT device is introduced in the future, the AI autonomously analyzes a protocol, dynamically generates an optimal linkage path, and continues to expand the system without software modification.

### Implementation Steps

Step 1: Automatic collection of network system information Through agent programs and APIs installed in site terminals, gateway devices, IoT devices, management PCs, and the like of a telephone network, a data communication network, a mobile communication network, a train control network, a passenger guidance system, a reservation system, an advertisement distribution system, a facility monitoring system, and the like operated by each railway business operator and its subsidiaries and affiliated companies, interface information, a service quality requirement, a communication protocol, a bandwidth, a delay tolerance value, a redundant configuration, a failure occurrence history, the number of users, traffic information, a sensor data collection cycle, an external linkage API specification, an encryption method, a security authentication method, a transaction processing capability, a database configuration, traffic information at a peak time, a distribution data capacity, a distribution timing, targeting information, an abnormality detection algorithm, a notification method, and the like are automatically collected and aggregated in an information collection unit on a server side. Specifically, in this Step 1, the information collection unit activates a lightweight data collection agent deployed in each site terminal and gateway device, and starts a distributed data scraping process. The information collection unit directly accesses a system call provided by an operating system of each device and a performance counter of hardware. The information collection unit acquires low-layer metrics such as a CPU usage rate, a memory consumption amount, the number of transmitted and received bytes of a network interface, and the number of packet drops at a resolution in units of microseconds. Input data to the information collection unit is a raw binary data stream asynchronously streamed from each device. The information collection unit deserializes the received binary data stream in accordance with a predefined protocol buffer schema. The information collection unit converts the deserialized data into a structured time-series data point consisting of a set of a timestamp, a device ID, and a metric value. The information collection unit aggregates these data points in a certain time window, and generates a feature vector for each node. Output data from the information collection unit is a huge state matrix tensor representing a current state of the entire system. The information collection unit applies an event-driven transmission algorithm that transmits data only when a data change amount exceeds a predetermined threshold value on the agent side so as not to compress a network bandwidth in a process of data collection. By this processing, the system aggregates a huge amount of telemetry data generated from devices on a scale of tens of thousands of units to the server side in real time and without loss without imposing a load on a network. The system exhibits a technical effect of continuously generating a high-quality input data set with less noise for a subsequent AI model to perform accurate inference. By continuously executing the processing of this Step 1 in the background while the system is operating, the system captures a minute state change of the network without missing it, and establishes a foundation for dynamic optimization control.
Step 2: Automatic analysis and generation of linkage path and service quality requirement Based on the detailed interface information and service quality requirement of each network system aggregated from the information collection unit, a linkage adjustment unit automatically determines which systems are to be linked with each other through what path and method, and generates a linkage path. For example, various linkage patterns are comprehensively and automatically designed, such as linkage between a mobile network and a reservation system, simultaneous linkage of train operation information to a passenger guidance system and an advertisement distribution system, linkage between a facility monitoring system and a train control network at the time of an abnormality, and interlocking between a guidance system and an advertisement distribution system when an event is held. Specifically, the linkage adjustment unit executes a route search algorithm using a graph neural network. The linkage adjustment unit generates a high-dimensional graph tensor having each network system as a node and a physical and logical connection link as an edge. The graph tensor holds a processing capability of each node and a bandwidth and a delay value of each edge as a feature vector. The linkage adjustment unit inputs the graph tensor to the graph neural network. The graph neural network executes a convolution operation on the input graph tensor. The graph neural network updates a hidden state vector of each node. The graph neural network outputs a probability distribution matrix indicating an optimal linkage path. The probability distribution matrix represents a probability that each edge is included in the linkage path by a floating-point number. For example, the probability distribution matrix outputs a probability of an edge passing through a specific firewall as 0.95 as a route from the mobile network to the reservation system. Further, the probability distribution matrix outputs a probability of an edge of a low-delay dedicated line as 0.98 as a route from the train operation information to the passenger guidance system. The linkage adjustment unit compares each element of the probability distribution matrix with a predetermined threshold value. The linkage adjustment unit connects edges exceeding the threshold value to determine a specific linkage path. By this processing, the system eliminates a conventional operation in which a human manually designs a network configuration. The system completes an optimal route search in a complex network topology in units of milliseconds. The system minimizes a communication delay and dramatically improves data transfer efficiency of the entire system. This technology is extremely useful as a real-time data linkage foundation between heterogeneous systems in a smart city.
Step 3: Automatic setting of protocol conversion and QoS control Based on the linkage path generated by the linkage adjustment unit, a protocol conversion unit automatically executes a necessary protocol conversion process between different network systems, and a QoS control unit automatically sets communication bandwidth allocation, delay control, packet priority setting, automatic switching of a redundant route, traffic shaping, application of encrypted communication, automatic recovery at the time of a failure occurrence, and the like in accordance with a service quality requirement required for each linkage path. Specifically, the protocol conversion unit incorporates a protocol mapping engine applying a natural language processing model. The protocol conversion unit parses a data format definition file of a transmission source system and a data format definition file of a destination system. The protocol conversion unit converts an analysis result into a word embedding vector. The protocol conversion unit inputs the word embedding vector to a transformer-based neural network. The neural network calculates a semantic relevance between fields using a self-attention mechanism. The neural network outputs a conversion matrix indicating an optimal data mapping rule. For example, the conversion matrix outputs a rule for mapping a timestamp field of the transmission source to an occurrence time field of the destination. Further, the conversion matrix outputs a function for converting a status code of the transmission source into a state flag of the destination. The protocol conversion unit dynamically rewrites a packet header and a payload in accordance with the conversion matrix. At the same time, the QoS control unit dynamically allocates a network resource using a reinforcement learning algorithm. The QoS control unit acquires a current traffic amount and packet loss rate of a network as a state vector. The QoS control unit inputs the state vector to a deep Q-network. The deep Q-network outputs an optimal bandwidth allocation amount for each linkage path as an action vector. The QoS control unit updates a queuing setting of a router or a switch based on the action vector. By this processing, the system completely prevents a communication error due to a protocol mismatch. The system autonomously controls traffic in accordance with a congestion state of the network. The system enhances certainty of packet arrival and dramatically improves communication quality. This technology is applicable to seamless communication control between heterogeneous devices in an industrial IoT environment.
Step 4: Dynamic optimization and reconfiguration by generative AI An AI control unit utilizes generative AI to flexibly and timely reconfigure the linkage path and the service quality setting generated by the linkage adjustment unit in accordance with a prompt input or an additional requirement. For example, dynamic reconfiguration and preventive operation are realized, such as temporarily raising QoS between a passenger guidance system and a train control system when a train schedule is disrupted, automatically adding a facility monitoring system of a new subsidiary to an existing linkage path, enhancing bandwidth allocation when the number of users of the passenger guidance system rapidly increases, and strengthening a bandwidth and a redundant setting when the number of users rapidly increases such as during year-end and New Year holidays or a long holiday. Specific examples of a prompt sentence to be read by the generative AI include “add a monitoring system of a construction-related subsidiary to data linkage newly”, “strengthen redundancy of a train control system”, “enhance a bandwidth of an advertisement distribution system when an event is held”, “automatically expand a bandwidth when the number of users of a passenger guidance system exceeds a threshold value”, “immediately notify a head office system when an abnormality is detected in a facility monitoring system”, “automatically adjust a transaction processing capability of a reservation system in accordance with a peak time”, “automatically switch to a backup route when a delay of a train control network exceeds a threshold value”, and “share distribution destination terminal information of an advertisement distribution system with a passenger guidance system in real time”. Specifically, the AI control unit includes a dynamic reconfiguration engine having a large language model as a core. The AI control unit acquires a natural language prompt sentence input from an administrator. The AI control unit tokenizes the prompt sentence and generates an input tensor. The AI control unit acquires current network topology information and a resource usage status as structured data. The AI control unit converts the structured data into a context vector. The AI control unit combines the input tensor and the context vector, and inputs them to the large language model. The large language model is composed of a transformer architecture having billions of parameters. The large language model analyzes the input information and outputs a specific command sequence for changing a network setting. The command sequence is output as structured data in a JSON format. For example, in response to an input to enhance a bandwidth of an advertisement distribution system, the large language model outputs a setting command to change a bandwidth limit of a specific virtual LAN from 500 megabits per second to 1 gigabit per second. Further, in response to an input to add a monitoring system, the large language model outputs a command to register a new IP address group in a routing table. The AI control unit verifies syntax validity of the output command sequence. The AI control unit transmits the command sequence that has passed the verification to a control interface of each network device. By this processing, the system saves time and effort for a human administrator to manually input a complex command. The system immediately changes a network configuration from an intuitive instruction by a natural language. The system significantly shortens a lead time of operation and maintenance, and eliminates a human error. This technology is extremely effective for autonomous network operation management of a large-scale data center.
Step 5: Linkage with site terminal and site optimization processing A site terminal linkage unit links with a terminal, a gateway device, an IoT device, a management PC, and the like installed in each network system, and executes information collection at a site, protocol conversion, QoS control, site optimization processing by an AI agent, an immediate response at the time of a failure occurrence, reception of a prompt input from the site, and the like. For example, various site linkages are realized, such as a site terminal automatically switching to a backup line when a failure occurs in a train control network, an advertisement distribution terminal automatically adjusting bandwidth allocation when the number of users rapidly increases, a facility monitoring terminal automatically recognizing an interface specification and reporting it to a server when a new sensor device is added, and a site worker transmitting a prompt from a voice input or a tablet terminal to transmit a site requirement to an AI control unit. Specifically, the site terminal linkage unit executes a lightweight inference model in an edge computing environment. The site terminal linkage unit operates on a microcontroller incorporated in each site terminal. The site terminal linkage unit acquires raw data from a sensor or a network interface at the site at a frequency of thousands of times per second. The site terminal linkage unit converts the acquired raw data into a one-dimensional time-series tensor. The site terminal linkage unit inputs the one-dimensional time-series tensor to a one-dimensional convolutional neural network on an edge side. The one-dimensional convolutional neural network extracts a local feature from input data, and outputs an abnormality detection score. The abnormality detection score takes a continuous value from 0 to 1. For example, the one-dimensional convolutional neural network receives a fluctuation of a packet arrival interval of the train control network as an input, and outputs 0.92 as the abnormality detection score. Further, the one-dimensional convolutional neural network receives a rapid increase in a CPU usage rate of the advertisement distribution terminal as an input, and outputs 0.85 as the abnormality detection score. When the abnormality detection score exceeds a preset threshold value, the site terminal linkage unit immediately executes a local failover process. The site terminal linkage unit invalidates a routing table of a main line, and validates an interface of a backup line. By this processing, the system makes an autonomous determination at the site without waiting for a communication delay with a central server. The system realizes recovery in units of milliseconds from the occurrence of a failure. The system maximizes availability of the entire network to the utmost limit. This technology is an indispensable technology in an in-vehicle network of an autonomous driving vehicle or a real-time control system of an industrial robot.
Step 6: Data accumulation and AI learning/operation optimization A data accumulation unit accumulates interface information, a service quality requirement, a communication history, a failure occurrence history, traffic information, user behavior data, a prompt input history, an optimization result by AI, and the like collected from each network system in chronological order, and utilizes them as learning data for generative AI. Using these data, the AI control unit realizes data-driven operation optimization, such as learning a past failure occurrence pattern to predict a future failure occurrence, analyzing user behavior data to optimize bandwidth allocation at a peak time, analyzing a prompt input history to grasp a tendency of a site requirement and generating an automation rule, and accumulating an optimization result by AI to reflect it in future decision making. Specifically, the data accumulation unit manages petabyte-class data using a distributed time-series database system. The data accumulation unit formats various collected data as a multidimensional vector with a timestamp. The data accumulation unit writes the multidimensional vector into a column-oriented storage engine. The AI control unit reads out the accumulated multidimensional vector group by batch processing. The AI control unit normalizes the read data, and constructs a learning data set for a long short-term memory network. The AI control unit updates a weight parameter of the long short-term memory network by an error backpropagation method using the learning data set. The long short-term memory network learns a time-series pattern of past traffic fluctuation and failure occurrence. The long short-term memory network outputs a load predicted value of each network link in a specific future time zone. The load predicted value is output as a numerical array having a unit of megabytes per second. For example, the long short-term memory network outputs 850 megabytes per second as a load predicted value of a main trunk link at 8:00 a.m. tomorrow. Further, the long short-term memory network outputs 0.15 as a failure occurrence probability in a specific router. The AI control unit generates a bandwidth allocation schedule of a network in advance based on the load predicted value. By this processing, the system shifts from reactive network management to predictive proactive network management. The system optimally allocates a resource before congestion or a failure occurs. The system maximizes operation efficiency of the network and brings downtime close to zero. This technology exhibits an extremely high effect in core network operation of a communication carrier and automatic optimization of a large-scale cloud infrastructure.

### Specific Use Case

For example, in a situation where a train control network, a passenger guidance system, an advertisement distribution system, a facility monitoring system, a reservation system, a mobile communication network, a data communication network, a telephone network, and the like operated by a plurality of business operators among a railway business operator group are constructed independently of each other, when it is necessary to realize real-time information linkage and optimization of service quality among these systems, the system of the present invention can be applied. Through an agent program or an API installed in each network system, an information collection unit automatically collects, for example, a control signal transmission method, a redundant configuration, a real-time requirement, a failure occurrence history, and the like from the train control network, a data update frequency, an external linkage API specification, the number of users, traffic information at a peak time, and the like from the passenger guidance system, a distribution data capacity, a distribution timing, distribution destination terminal information, targeting information, and the like from the advertisement distribution system, a type of sensor data, a data collection cycle, an abnormality detection algorithm, a notification method, and the like from the facility monitoring system, a transaction processing capability, a database configuration, an external linkage interface, and the like from the reservation system, a wireless standard, base station information, a terminal authentication method, a communication area, and the like from the mobile communication network, an Ethernet standard, a VLAN configuration, a traffic amount, and the like from the data communication network, and a line type, a communication protocol, a bandwidth, and the like from the telephone network. Specifically, the information collection unit implements a parallel polling engine using multi-thread processing. The information collection unit allocates a dedicated data collection thread to each independent system. The information collection unit periodically transmits an API request for state acquisition through each thread. The information collection unit asynchronously receives response data in a JSON format or an XML format returned from each system. The information collection unit parses the received response data, and extracts a system-specific parameter. The information collection unit normalizes the extracted parameter in accordance with a common data schema. The information collection unit stores the normalized data as a feature vector in an in-memory database on a memory. The feature vector is represented as a floating-point number array of several hundred dimensions. For example, the information collection unit stores a delay requirement acquired from the train control network as a numerical value in units of milliseconds in a first element of the feature vector. Further, the information collection unit stores a free capacity of a base station acquired from the mobile communication network as a percentage in a second element of the feature vector. The information collection unit stores the number of transactions per second acquired from the reservation system as an integer value in a third element of the feature vector. The information collection unit streaming-transfers these feature vectors to a subsequent linkage adjustment unit. By this processing, the system comprehensively collects state information in real time from a siloed heterogeneous system group. The system absorbs a difference in data format between systems, and provides a unified analysis foundation. The system dramatically improves visibility of the entire large-scale infrastructure. This technology functions as a cornerstone of data integration in a consortium-type smart mobility foundation in which a plurality of companies participate.

The linkage adjustment unit generates a linkage path that links, for example, a passenger guidance system and a train control network to update a passenger guidance display in real time when a train operation status changes, and simultaneously generates a linkage path that also links with an advertisement distribution system to distribute an advertisement interlocked with specific operation information or event information to a passenger guidance terminal. A linkage path that links a facility monitoring system and the train control network to automatically transmit a control signal when an abnormality is detected and ensure safety of train operation is also generated. A linkage path that links a reservation system and a mobile communication network to notify a mobile terminal of user reservation information in real time is generated. Necessary protocol conversion and QoS control are automatically set for each of these linkage paths, and for example, a low-delay and highly reliable communication route is automatically applied between the passenger guidance system and the train control network, bandwidth enhancement at a peak time is automatically applied between the advertisement distribution system and the passenger guidance system, immediate notification at the time of abnormality detection is automatically applied between the facility monitoring system and the train control network, and secure data transfer is automatically applied between the reservation system and the mobile communication network. Specifically, the linkage adjustment unit simultaneously optimizes a plurality of linkage paths using a multi-agent reinforcement learning algorithm. The linkage adjustment unit allocates a generation task of each linkage path to an independent learning agent. The linkage adjustment unit gives a bandwidth and a delay constraint of the entire network to each agent as a shared environmental state. The linkage adjustment unit defines selection of a routing route between specific nodes and allocation of a QoS class as an action of each agent. The linkage adjustment unit calculates a reward based on communication efficiency and a requirement achievement degree of the entire system for a combination of actions selected by each agent. The linkage adjustment unit updates a policy network of each agent so as to maximize the reward. The policy network outputs a configuration parameter of an optimal linkage path. For example, the policy network outputs a QoS setting of the highest priority that guarantees a delay of 1 millisecond or less for a linkage path between the passenger guidance system and the train control network. Further, the policy network outputs a setting to allocate a bandwidth of 10 gigabits per second for a linkage path between the advertisement distribution system and the passenger guidance system. The policy network outputs a construction command of an encrypted tunnel for a linkage path between the reservation system and the mobile communication network. The linkage adjustment unit transmits these output parameters to a controller of each network device to reflect the setting. By this processing, the system simultaneously establishes linkage between a plurality of systems having conflicting communication requirements without contradiction. The system dynamically allocates a limited network resource to communication with the highest value. The system completely automates design and setting work of complex inter-system linkage. This technology is extremely important in an integrated network environment in which mission-critical communication and best-effort communication coexist.

The AI control unit utilizes generative AI to read prompt sentences into the generative AI, such as “automatically expand the bandwidth when the number of users of the passenger guidance system exceeds a threshold”, “add a monitoring system of a construction-related subsidiary to data linkage newly”, “automatically switch to a backup path when the delay of the train control network exceeds a threshold”, “share distribution destination terminal information of the advertisement distribution system with the passenger guidance system in real time”, “automatically adjust the transaction processing capacity of the reservation system in accordance with a peak time”, “immediately notify the head office system when an abnormality is detected in the facility monitoring system”, “strengthen the redundancy of the train control system”, and “increase the bandwidth of the advertisement distribution system when an event is held”, and flexibly and timely reconfigures the linkage path and the service quality setting based on these instructions. For example, dynamic optimization is realized, such as increasing the bandwidth of the linkage path between the passenger guidance system and the advertisement distribution system when an event is held to cope with a rapid increase in the number of users, automatically incorporating a new facility monitoring system into an existing linkage path when it is added, or immediately switching to a backup path when a failure occurs. Specifically, the AI control unit adopts a hybrid architecture integrating a natural language understanding model and a rule generation engine. The AI control unit converts the input prompt sentence into an abstract syntax tree by morphological analysis and syntax analysis. The AI control unit inputs the abstract syntax tree to a transformer encoder to generate a context embedding vector. The AI control unit inputs the embedding vector to a decoder network. The decoder network generates an executable script and a configuration file interpretable by a network device. The decoder network outputs a logical structure including conditional branching and loop processing. For example, the decoder network outputs a condition that the number of users exceeds a threshold as a code of an event listener that receives a state monitoring trap. Further, the decoder network outputs an action to expand the bandwidth as a script that calls an API of a network controller to rewrite a bandwidth limitation parameter. The decoder network outputs an instruction to switch to a backup path as a router setting command that changes a priority value of a routing protocol. The AI control unit test-executes the generated script in a sandbox environment to verify that it does not adversely affect existing communication. The AI control unit deploys the successfully verified script to an orchestrator in a production environment. By this processing, the system automatically converts a human's ambiguous intention into a strict computer program. The system executes dynamic reconfiguration of the network according to a change in situation without downtime. The system realizes a high degree of automation without depending on the programming skill of an operation manager. This technology functions as a core technology for realizing intent-based networking.

A site terminal linkage unit realizes various site linkages, for example, a gateway device at a site automatically switches to a backup line when a failure occurs in the train control network, an advertisement distribution terminal automatically adjusts bandwidth allocation when the number of users rapidly increases, a facility monitoring terminal automatically recognizes an interface specification and reports it to a server when a new sensor device is added, and a site worker transmits a prompt from a voice input or a tablet terminal to transmit a site requirement to the AI control unit. Specifically, the site terminal linkage unit operates as a containerized microservice deployed in each site terminal. The site terminal linkage unit executes a daemon process that monitors hardware resources of the terminal. The site terminal linkage unit captures an interrupt signal from a connected peripheral device or sensor in real time. When detecting that a new sensor device is physically connected, the site terminal linkage unit reads descriptor information of a communication interface. The site terminal linkage unit extracts an identifier of the device from the descriptor information. The site terminal linkage unit searches a local device catalog database based on the extracted identifier, and specifies an appropriate communication protocol and data format. The site terminal linkage unit formats the specified specification information as metadata in a JSON format. For example, the site terminal linkage unit generates metadata indicating that a serial communication protocol is used and a 16-bit integer value is output as a specification of a newly connected temperature sensor. Further, the site terminal linkage unit acquires a voice input of a site worker from a microphone, and converts it into text data using a local voice recognition model. The site terminal linkage unit transmits the text data as a prompt to the central AI control unit via a secure communication path. By this processing, the system immediately reflects a physical change at the site and a request of the worker to the entire system. The system enables automatic recognition and setting of a device by plug and play. The system significantly reduces a load on the central server by autonomous edge processing according to the situation at the site. This technology has extremely high practicality in efficient management and operation of an IoT device group distributed over a wide area.

A data accumulation unit accumulates the interface information, the service quality requirement, a communication history, a failure occurrence history, traffic information, user behavior data, a prompt input history, an optimization result by AI, and the like collected from each network system in chronological order, and realizes data-driven operation optimization, such as the AI control unit learning a past failure occurrence pattern using these data to predict a future failure occurrence, analyzing the user behavior data to optimize bandwidth allocation at a peak time, analyzing the prompt input history to grasp a tendency of a site requirement and generating an automation rule, and accumulating the optimization result by the AI to reflect it in future decision making. Specifically, the data accumulation unit adopts a data lake architecture constructed on a distributed file system. The data accumulation unit stores structured data, semi-structured data, and unstructured data in formats according to their respective characteristics. The data accumulation unit compresses and stores the communication history and the traffic information as a column-oriented file. The data accumulation unit stores the prompt input history and a log of the optimization result as an index of a search engine. The AI control unit executes large-scale data mining using a distributed processing framework on the data lake. The AI control unit analyzes a correlation between the past failure occurrence history and the traffic information using a random forest algorithm. The AI control unit extracts a combination of specific feature amount patterns that is a sign of a failure. The AI control unit outputs the extracted pattern as a decision tree model. For example, the AI control unit outputs a prediction rule that a link down will occur within 10 minutes when a state in which a CPU usage rate of a specific router exceeds 80% and a packet loss rate exceeds 2% continues for 5 minutes. Further, the AI control unit applies a topic model to the prompt input history, and clusters a tendency of setting changes frequently requested by site workers. The AI control unit generates a frequently appearing request pattern as a template of an automation script. By this processing, the system discovers a hidden regularity unnoticed by humans from a huge amount of operation data. The system realizes preventive maintenance based on objective data that does not depend on an empirical rule. The system enables self-evolution and continuous operation improvement of the system. This technology is an indispensable component as an IT operation infrastructure using artificial intelligence for a large-scale network.

As described above, the system of the present invention can realize linkage, adjustment, and optimization among a plurality of independent network systems in real time and flexibly by automation utilizing generative AI and close linkage with site terminals. Specifically, the system seamlessly integrates advanced inference capability by a large language model on a centralized cloud and ultra-low latency autonomous control by a lightweight machine learning model distributed and arranged on the edge side. The system includes a stream processing engine that processes multidimensional telemetry data collected from each network node in real time. The system dynamically recalculates a topology and resource allocation of the entire network based on a feature amount vector extracted by the stream processing engine. The system applies the recalculated optimal configuration parameter to each physical device and virtual network function in units of milliseconds via a network controller. The system continuously executes this series of feedback loops without human intervention. By this processing, the system strictly maintains a service level agreement of the entire system even against a sudden rapid increase in traffic or a physical failure of hardware. The system solves an optimization problem in an extremely dynamic and complex communication environment, which cannot be handled by a conventional static network design. The system dramatically reduces an operation cost of a communication infrastructure and dramatically improves service quality for end users. This technology is widely applicable as a backbone control architecture in constructing a next-generation communication network and a fully autonomous smart city infrastructure.

(Application Example 1) The flow of the specific processing in Application Example 1 will be described. Each part of the system described below is realized by the data processing device 12 and the smart device 14. Additionally, the data processing device 12 is referred to as a “server,” and the smart device 14 is referred to as a “terminal.”

### Embodiment for Carrying Out the Present Invention

Embodiments for carrying out the present invention will be described more specifically and in detail. The present invention automatically and flexibly links and optimizes a plurality of independent systems constituting urban infrastructure and resident services by an integrated gateway using generative AI, and can realize various inter-system linkages in real time and dynamically in all usage scenes of a city. Specifically, the integrated gateway functions as a distributed message broker that accommodates data streams from millions of IoT devices and various server groups distributed throughout the city with a single logical interface. The integrated gateway adopts a publish-subscribe model and mediates asynchronous communication between the respective systems. The integrated gateway incorporates an in-memory stream processing engine that analyzes a payload of a received message in real time. The integrated gateway extracts metadata indicating a transmission source, a data type, and an urgency level of each message using the stream processing engine. The integrated gateway converts the extracted metadata into a multidimensional tensor, and inputs it to an inference pipeline of the generative AI. The generative AI determines an optimal routing destination of the message and necessary data conversion processing based on the input multidimensional tensor. The generative AI outputs the determination result as an update command of a routing table. By this processing, the system dynamically resolves a complex dependency relationship among heterogeneous systems constituting the urban infrastructure. Even when a failure occurs in a specific system, the system instantaneously establishes a path to an alternative system to prevent a stoppage of urban functions. The system destroys data silos and provides a foundation for cross-sectionally utilizing data of the entire city. This technology plays an extremely important role in data-driven smart city operation and resilience enhancement at the time of a large-scale disaster.

First, the information collection unit automatically collects interface information, a service quality requirement, a communication protocol, a bandwidth, a delay tolerance value, a redundant configuration, a failure occurrence history, the number of users, traffic information, a sensor data collection cycle, an external linkage API specification, an encryption method, a security authentication method, a transaction processing capacity, a database configuration, peak-time traffic information, a distribution data capacity, a distribution timing, targeting information, an abnormality detection algorithm, a notification method, and the like from various network systems constituting the city, such as a traffic control system, a power supply system, a disaster prevention warning system, an environmental sensor network, a resident information service, a water and sewage monitoring system, a medical institution network, an educational institution network, a logistics base system, and an administrative procedure system in the city. For example, a signal control API, traffic volume data API, emergency contact API, traffic light state, traffic congestion information, automatic notification at the time of an accident occurrence, emergency vehicle priority control information, traffic regulation information at the time of an event, and the like are automatically collected from the traffic control system; a supply and demand adjustment API, power monitoring data, failure notification, power consumption, peak power demand, operation status of distributed power sources, power outage occurrence history, priority supply information to critical infrastructure, and the like are automatically collected from the power supply system; an earthquake warning API, evacuation instruction API, fire detection data, disaster occurrence history, tsunami warning, landslide disaster warning, evacuation shelter opening information, resident safety information at the time of a disaster, and the like are automatically collected from the disaster prevention warning system; an atmospheric data API, noise data, temperature and humidity data, PM2.5 concentration, abnormality detection information, pollen scattering amount, ultraviolet ray amount, river water level data, and the like are automatically collected from the environmental sensor network; an application notification API, administrative procedure API, event information, resident attribute information, the number of users, emergency bulletin distribution history, questionnaire result, feedback information from residents, and the like are automatically collected from the resident information service; water quality data, flow rate data, abnormality detection data, emergency shutoff control API, water leakage detection information, pump operation status, operation data of a water purification plant, load information of a sewage treatment plant, and the like are automatically collected from the water and sewage monitoring system; a patient information linkage API, emergency transport information, medical equipment operation status, disaster medical system information, vaccine inventory information, infectious disease occurrence status, remote medical care data, shift information of medical workers, and the like are automatically collected from the medical institution network; an attendance management API, remote class data, emergency contact API, educational content distribution information, school event information, student safety confirmation information, guardian contact history, learning progress data, and the like are automatically collected from the educational institution network; a delivery status API, inventory data, delivery route information, emergency delivery instruction, drone delivery status, temperature and humidity management data of a warehouse, package tracking information, position information of a delivery vehicle, and the like are automatically collected from the logistics base system; and an application reception API, resident card issuance data, special procedure information at the time of a disaster, My Number linkage information, tax processing status, subsidy application status, congestion information of an administrative counter, electronic signature data, and the like are automatically collected from the administrative procedure system. Specifically, the information collection unit includes a schema-on-read type data integration engine for uniformly handling various data formats provided by the respective systems. The information collection unit issues a highly efficient data acquisition request to an endpoint of each system. The information collection unit temporarily stores the acquired raw data in a buffer on a memory. The information collection unit automatically assigns a semantic tag from a field name or metadata of each data using natural language processing technology. The information collection unit structures the tagged data as a multidimensional knowledge graph. The knowledge graph expresses each system as a node and a data dependency relationship or a physical positional relationship as an edge. The information collection unit assigns the collected parameter as an attribute value to each node of the knowledge graph. For example, the information collection unit assigns a congestion length of a current intersection as a floating-point number in meters to a node of the traffic control system. Further, the information collection unit assigns a concentration of fine particulate matter as a numerical value in micrograms per cubic meter to a node of the environmental sensor network. The information collection unit assigns the number of available emergency beds as an integer value to a node of the medical institution network. The information collection unit persists the constructed knowledge graph in a graph database to enable a response to a complex query from the subsequent linkage adjustment unit. By this processing, the system integrates a huge amount of various data scattered in the city as one huge data set linked semantically. The system eliminates data silos between systems and makes it possible to grasp the situation of the entire city in real time from a bird's-eye view. The system completely automates the process of data collection and structuring, and eliminates manual work by a data engineer. This technology is extremely effective as a basic data collection mechanism for constructing a digital twin of a city.

The linkage adjustment unit automatically determines which systems are to be linked with each other through what path and method based on the detailed interface information and service quality requirement of each system aggregated from the information collection unit, and generates a linkage path. For example, the traffic control system and the disaster prevention warning system are linked to generate a linkage path that automatically controls traffic signals and secures an evacuation route when an earthquake occurs. Furthermore, the resident information service and the disaster prevention warning system are linked to generate a linkage path that immediately distributes an evacuation instruction and disaster information to a smartphone or digital signage of a resident. The power supply system and the medical institution network are linked to generate a linkage path that automatically controls priority power supply to an important medical institution during a power outage. The environmental sensor network and the traffic control system are linked to generate a linkage path that restricts traffic volume in a specific area when air pollution exceeds a reference value. The water and sewage monitoring system and the disaster prevention warning system are linked to generate a linkage path that automatically executes emergency shutoff of sewage in conjunction with a flood warning during heavy rain. The logistics base system and the traffic control system are linked to generate a linkage path that automatically secures an emergency relief supply delivery route at the time of a disaster. The educational institution network and the resident information service are linked to generate a linkage path that immediately distributes safety information of students to guardians at the time of a disaster. The administrative procedure system and the resident information service are linked to generate a linkage path that promptly notifies residents of special procedure information and support measures at the time of a disaster. Furthermore, it is possible to flexibly respond to various events and emergencies in the city, for example, by linking the traffic control system and the resident information service when a city marathon is held to generate a linkage path that notifies residents of traffic regulation information and detour routes in real time, linking the environmental sensor network and the medical institution network when a heatstroke warning is issued in summer to generate a linkage path that strengthens an emergency transport system, and linking the medical institution network and the educational institution network when an infectious disease is prevalent to generate a linkage path that distributes school closure information and remote class information to students and guardians. Specifically, the linkage adjustment unit executes a hybrid optimization engine combining a constraint satisfaction problem solver and an evolutionary algorithm. The linkage adjustment unit receives the knowledge graph constructed by the information collection unit as an input. The linkage adjustment unit formulates a linkage requirement between the respective systems as a logical expression. The linkage adjustment unit sets a bandwidth, a delay, and a security level of the network as constraint conditions. The linkage adjustment unit generates a candidate group of linkage paths satisfying these constraint conditions using the evolutionary algorithm. The linkage adjustment unit applies a fitness function to each candidate path to calculate a score. The fitness function comprehensively evaluates communication reliability, delay minimization, and resource consumption efficiency. The linkage adjustment unit selects a linkage path that has acquired the highest score as an optimal solution. The linkage adjustment unit outputs the selected linkage path as a specific routing setting or a routing rule of an API gateway. For example, the linkage adjustment unit outputs a setting for establishing a dedicated low-latency virtual private network tunnel as a linkage path between the traffic control system and the disaster prevention warning system when an earthquake occurs. Further, the linkage adjustment unit outputs a setting for asynchronous communication via a message queuing system as a linkage path between the environmental sensor network and the traffic control system at the time of air pollution. The linkage adjustment unit outputs a setting of a data stream to which a high-priority QoS tag is added as a linkage path between the environmental sensor network and the medical institution network at the time of a heatstroke warning. By this processing, the system derives an optimal linkage configuration in units of milliseconds from among countless combinations of systems in accordance with a change in the situation of the city. The system mathematically solves complex constraint conditions that cannot be fully considered by a human designer. The system autonomously constructs the most effective inter-system linkage for an event or disaster in the city. This technology is a core technology for realizing cross-domain service orchestration in a smart city.

The AI control unit utilizes generative AI to flexibly and timely reconfigure the linkage path and the service quality setting generated by the linkage adjustment unit in accordance with a prompt input or an additional requirement. For example, by giving prompts to the generative AI, such as “give top priority to linkage between the disaster prevention warning system and the traffic control system when a large-scale earthquake occurs, and make evacuation information distribution to the resident information service immediate”, “give top priority to notification to the resident information service when an air pollution warning is issued, and restrict traffic volume in a specific area in linkage with the traffic control system”, “strengthen linkage between the disaster prevention warning system and the resident information service when a power failure occurs, and notify a power supply status to critical infrastructure in real time”, “add a logistics base system to an emergency delivery network newly”, “notify local residents of emergency transport information of the medical institution network in linkage with the resident information service”, “immediately distribute an emergency contact API of the educational institution network to guardians in linkage with the resident information service”, “strengthen linkage between the traffic control system and the resident information service when a city marathon is held, and notify traffic regulation information in real time”, and “strengthen linkage between the environmental sensor network and the medical institution network when a heatstroke warning is issued, and strengthen an emergency transport system”, the AI automatically optimizes and reconfigures the linkage path and the service quality setting based on these instructions. For example, when an earthquake occurs, the QoS of the linkage path between the disaster prevention warning system and the traffic control system is maximized, evacuation information distribution to the resident information service is made immediate, and emergency transport information linkage to the medical institution network is strengthened, whereby the safety and service quality of the entire city can be dynamically optimized. Specifically, the AI control unit implements a large language model fine-tuned to understand the context of the city. The AI control unit receives a natural language prompt input from a city manager as a text tensor. The AI control unit generates sensor data and traffic information indicating the current situation of the city as a context tensor. The AI control unit combines the text tensor and the context tensor, and supplies them to an input layer of the large language model. The large language model calculates the relevance between the intention in the prompt and the current city situation using a self-attention mechanism. The large language model generates a sequence of specific control commands for each system of the urban infrastructure. The control command is output as a declarative configuration file. For example, the large language model outputs a configuration file that raises the priority of the signal control API of the traffic control system to the highest level in response to a prompt when a large-scale earthquake occurs. Further, the large language model outputs a configuration file that changes the data transmission frequency of the environmental sensor network from a 5-minute interval to a 1-minute interval and doubles the data transfer bandwidth to the medical institution network in response to a prompt when a heatstroke warning is issued. The AI control unit automatically applies the output configuration file to an edge router or an API gateway of each system through a configuration management tool. By this processing, the system automatically translates an abstract policy of the city manager into a specific setting value of a physical network device or server group. The system eliminates the time for a human to manually change settings in an emergency, and enables an immediate response. The system dramatically enhances the adaptability of the system to changes in the situation of the city. This technology provides an extremely innovative approach in autonomous operation management of a software-defined urban infrastructure.

A protocol conversion unit automatically executes various protocol conversion processes when communication protocols are different between different systems, for example, converting a signal control API of the traffic control system into an evacuation instruction API of the disaster prevention warning system, converting a supply and demand adjustment API of the power supply system into a priority power supply API of the medical institution network, converting an atmospheric data API of the environmental sensor network into a traffic volume control API of the traffic control system, converting a water quality data API of the water and sewage monitoring system into a flood warning API of the disaster prevention warning system, and converting a delivery status API of the logistics base system into an emergency vehicle priority control API of the traffic control system. Specifically, the protocol conversion unit is equipped with a semantic data mapping engine using deep learning. The protocol conversion unit extracts a payload of a packet received from a transmission source system as a byte array. The protocol conversion unit inputs the byte array to a recurrent neural network, and analyzes the structure and meaning of data. The recurrent neural network extracts a key-value pair from the input data, and generates an intermediate representation vector. The protocol conversion unit inputs the intermediate representation vector to a decoder network based on a protocol specification of a destination system. The decoder network generates a new payload in a format interpretable by the destination system. For example, the decoder network receives signal state data in a binary format received from the traffic control system as an input, and outputs an evacuation instruction message in a JSON format for the disaster prevention warning system. Further, the decoder network receives an atmospheric data message of a message queuing protocol received from the environmental sensor network as an input, and outputs an HTTP request for the traffic control system. The decoder network receives delivery status data in an XML format received from the logistics base system as an input, and outputs stream data for the traffic control system. The protocol conversion unit adds an appropriate header to the generated payload, and transmits it to the destination system. By this processing, the system completely eliminates a communication barrier between a legacy system and the latest cloud-native system. The system reduces the cost of developing an individual conversion program for each system to zero. The system prevents a communication error due to a mismatch of data formats, and guarantees reliable data linkage. This technology is an essential technology for ensuring interoperability in a smart city environment where devices of various vendors coexist.

A QoS control unit executes communication bandwidth allocation, delay control, packet priority setting, automatic switching of a redundant path, traffic shaping, application of encrypted communication, automatic recovery at the time of a failure occurrence, and the like in accordance with a service quality requirement required for each linkage path. For example, fine-grained QoS control is performed, such as maximizing a communication bandwidth between the disaster prevention warning system and the traffic control system at the time of a disaster occurrence and immediately distributing a notification to the resident information service with minimum delay, automatically applying a redundant path to a linkage path between the medical institution network and the power supply system, applying encrypted communication to communication between the environmental sensor network and the traffic control system, applying packet priority setting to communication between the logistics base system and the traffic control system, and applying traffic shaping to communication between the educational institution network and the resident information service. Specifically, the QoS control unit executes dynamic traffic engineering utilizing software-defined network technology. The QoS control unit holds a topology of the entire network and a current used bandwidth of each link as a state matrix. The QoS control unit acquires the service quality requirement of each linkage path as a constraint vector. The QoS control unit inputs the state matrix and the constraint vector to a linear programming solver. The linear programming solver calculates a bandwidth allocation amount of each flow that maximizes the utility of the entire network. The QoS control unit rewrites a flow table of each switch using a network control protocol based on the calculated bandwidth allocation amount. For example, the QoS control unit applies a flow rule that sets a priority value to the highest level for traffic from the disaster prevention warning system at the time of a disaster occurrence to a switch. Further, the QoS control unit sets a fast failover group that duplicates and transmits a packet to both a main path and a backup path for communication between the medical institution network and the power supply system. The QoS control unit transmits a command instructing establishment of an encrypted tunnel to a security gateway for communication from the environmental sensor network. The QoS control unit sets a rate limit using a token bucket algorithm for large-capacity video distribution traffic from the educational institution network. By this processing, the system preferentially allocates limited urban network resources to the most critical communication. The system completely prevents delay and packet loss of important data due to network congestion. The system ensures confidentiality and integrity of communication, and protects the urban infrastructure from a cyber attack. This technology is indispensable for realizing a highly reliable network infrastructure supporting mission-critical urban services.

The site terminal linkage unit links with a terminal, a gateway device, an IoT device, a management PC, and the like installed in each system, and executes information collection at a site, protocol conversion, QoS control, a site optimization process by an AI agent, an immediate response when a failure occurs, reception of a prompt input from the site, and the like. For example, various site linkages are realized, such as a site terminal automatically switching to a backup path when a failure occurs in a traffic control system, an information service terminal for residents automatically adjusting bandwidth allocation when the number of users rapidly increases, an environmental sensor network terminal automatically recognizing an interface specification and reporting it to a server when a new sensor device is added, a site worker transmitting a prompt from a voice input or a tablet terminal to transmit a site requirement to the AI control unit, a site terminal at a logistics base automatically linking an emergency delivery instruction to the traffic control system, and a site terminal at a medical institution immediately notifying the information service for residents of emergency transport information. Specifically, the site terminal linkage unit manages a distributed edge node group based on a fog computing architecture. The site terminal linkage unit executes a lightweight container orchestration tool on each edge node. The site terminal linkage unit dynamically deploys a container image for executing a specific task from a central server to each edge node. The edge node executes a local inference model within the deployed container. The edge node processes a data stream from a connected sensor or device in real time. For example, the edge node receives a video stream from a camera installed at an intersection as an input, and detects an occurrence of an accident using an object detection model. When detecting the accident, the edge node directly transmits a switching command to a red light to a nearby traffic light controller without going through the central server. Further, the edge node functions as a gateway installed in the medical institution, and calculates an estimated arrival time of an ambulance. The edge node directly transfers the calculated estimated time to a local distribution server of the information service for residents. The edge node acquires text data of a natural language input from the tablet terminal of the site worker, and extracts an intention using a local natural language processing model. The edge node generates a control command based on the extracted intention, and applies it to a target device. By this processing, the system eliminates a communication delay to a cloud, and realizes ultra-low delay autonomous control at the site. The system maintains minimum urban functions even in an offline environment where a wide area network is disconnected. The system significantly reduces a processing load of the central server and consumption of a communication bandwidth. This technology has a decisive advantage in terminal control of urban infrastructure where real-time performance is extremely required.

The data accumulation unit accumulates the interface information, the service quality requirement, a communication history, a failure occurrence history, traffic information, user behavior data, a prompt input history, an optimization result by AI, and the like collected from each system in chronological order, and realizes data-driven operation optimization such that the AI control unit learns a past failure occurrence pattern using these data to predict a future failure occurrence, analyzes the user behavior data to optimize bandwidth allocation at a peak time, analyzes the prompt input history to grasp a tendency of a site requirement and generate an automation rule, and accumulates the optimization result by the AI to reflect it in future decision making. For example, it contributes to sophistication of urban operation, such as analyzing a communication traffic history at the time of a past large-scale disaster to prepare an optimal bandwidth allocation and linkage path in advance when a disaster occurs in the future, analyzing feedback information of residents to optimize a timing and content of information distribution, and analyzing a delivery history of a logistics base to automatically generate an emergency delivery route at the time of a disaster. Specifically, the data accumulation unit constructs a distributed data warehouse capable of processing petabyte-scale data. The data accumulation unit captures data streamed from each system in real time, adds a time stamp and geospatial coordinates, and stores the data as a multidimensional cube. The AI control unit applies a tensor decomposition algorithm to the multidimensional cube, and extracts a latent feature vector hidden in the data. The AI control unit inputs the extracted feature vector as an environmental state of a deep reinforcement learning model. The deep reinforcement learning model reproduces a traffic fluctuation pattern at the time of a past disaster in a simulation environment, and learns an optimal network control policy. The deep reinforcement learning model outputs a predefined setting template group for a specific disaster scenario as a learning result. For example, the deep reinforcement learning model outputs a matrix indicating a bandwidth allocation ratio of each system when an earthquake with a seismic intensity of 6 or higher occurs. Further, the AI control unit performs sentiment analysis on the feedback information of the residents and a usage history of an application using a natural language processing model. The AI control unit outputs a parameter for determining an optimal time zone for information distribution and a tone of a message based on an analysis result. The AI control unit inputs past GPS tracking data of the logistics base to a graph neural network, and outputs a probability distribution of a detour route in consideration of a road disconnection risk. By this processing, the system crystallizes past experience data as collective intelligence of a city. The system instantaneously derives an optimal countermeasure from a past similar pattern even for an unknown event. The system evolves the operation of the urban infrastructure from a reactive response to proactive predictive control. This technology functions as a brain for realizing a resilient and sustainable smart city.

The user interface unit provides a GUI, a dashboard, a voice input interface, an application for a mobile terminal, and the like for a system administrator and a site worker to perform state monitoring of the system, a prompt input, confirmation and change of a linkage path and a QoS setting, a response instruction when a failure occurs, confirmation of an optimization proposal by AI, history reference of the data accumulation unit, and the like. For example, various user interfaces are realized, such as the administrator grasping a linkage status and a QoS setting of the entire city at a glance on the dashboard, the site worker inputting a prompt in a natural language from a tablet terminal, transmitting an immediate response instruction to the AI control unit by voice input when a failure occurs, the administrator approving or rejecting the optimization proposal by the AI, a resident changing a reception setting of information distribution from a smartphone application, and an administrative official immediately distributing special procedure information at the time of a disaster. Specifically, the user interface unit generates an urban digital twin dashboard using three-dimensional graphics technology. The user interface unit acquires real-time traffic information and a status of a device from the data accumulation unit. The user interface unit superimposes and displays the acquired data on a three-dimensional urban model as a heat map or a particle animation. The user interface unit pop-up displays a detailed parameter of a related network device when the administrator clicks a model of a specific building or intersection. The user interface unit provides a chatbot interface incorporating a natural language processing model. The chatbot interface receives a text input or a voice input from the administrator. The chatbot interface converts the input voice into a mel-frequency cepstral coefficient, inputs it to a speech recognition neural network, and converts it into text. The chatbot interface transmits the text-converted prompt to the AI control unit. The user interface unit visually presents the optimization proposal returned from the AI control unit as a difference graph of a network topology before and after a change. The user interface unit renders execution buttons for approval and rejection on a screen together with the difference graph. When the administrator presses the approval button, the user interface unit issues an API call for setting application to a backend system. By this processing, the system presents an internal state of extremely complex urban infrastructure to a human in an intuitively understandable form. The system enables even an operator without advanced specialized knowledge to make an accurate decision with the support of AI. The system facilitates cooperative work between a human and AI, and maximizes operation efficiency of the system. This technology becomes a standard model of a human-machine interface in a next-generation urban operation center.

As described above, the embodiment of the present invention automatically and flexibly realizes integrated linkage, adjustment, and optimization of various systems constituting a city by utilizing generative AI, and can dynamically satisfy various requirements required for a smart city in real time, such as efficiency improvement of urban operation, enhancement of disaster response capability, sophistication of resident services, reduction of operation costs, rapid recovery at the time of a system failure, dynamic response at the time of an urban event, resident-participatory information distribution, and safety improvement of the entire city. Specifically, the system processes enormous stream data generated from millions of IoT sensors and edge devices distributed and arranged throughout the city in real time in a central parallel computing cluster. The system maps the collected heterogeneous data to a high-dimensional tensor space. The system applies a deep learning model equipped with a self-attention mechanism to the mapped tensor data. The deep learning model extracts a current state vector of the city from the input tensor data. The system calculates an optimal control parameter of the urban infrastructure based on the extracted state vector. The system transmits the calculated control parameter to each subsystem with a delay in milliseconds. The system completely eliminates manual intervention by a human operator through this series of processing. By eliminating the manual intervention, the system dramatically shortens an initial response time when a disaster occurs from several tens of minutes in the past to several milliseconds. In the system, this improvement in processing speed brings about a direct technical effect of minimizing damage. The system predicts a minute fluctuation in traffic volume and power demand even in normal times. The system executes dynamic allocation of resources based on a prediction result. The system significantly reduces energy consumption of the entire city by this dynamic allocation. The system realizes these processes not by a rule-based heuristic algorithm but by nonlinear function approximation learned from enormous past operation data. The system enables robust control even for an unknown complex event by this nonlinear function approximation. The system models an interdependence between systems as a graph structure in a specific use case such as traffic control, power grid control, and a disaster prevention system in the smart city. The system quantitatively evaluates an influence of a failure in a certain system on another system using a graph neural network. The system derives an optimal reconfiguration procedure of a network topology for localizing the influence based on an evaluation result. The system automatically executes the derived procedure, thereby maximizing availability of the urban infrastructure. The system receives, as input data, for example, a one-dimensional array indicating the number of vehicles at each intersection and a numerical vector indicating power consumption in each area. The system outputs, as output data, structured data including a numerical value indicating a duration of a green light of each traffic light and a numerical value indicating an output voltage of each substation. The system transmits this output data to a subsequent control module, and directly controls an operation of a physical infrastructure device.

### System Configuration

The system according to the present embodiment includes an information collection unit, a linkage adjustment unit, an AI control unit, a protocol conversion unit, a QoS control unit, a site terminal linkage unit, a data accumulation unit, and a user interface unit. The information collection unit automatically collects interface information, a service quality requirement, a communication protocol, a bandwidth, a delay tolerance value, a redundant configuration, a failure occurrence history, the number of users, traffic information, a sensor data collection cycle, an external linkage API specification, an encryption method, a security authentication method, a transaction processing capability, a database configuration, peak traffic information, a distribution data capacity, a distribution timing, targeting information, an anomaly detection algorithm, a notification method, and the like from various network systems constituting the city, such as a traffic control system, a power supply system, a disaster prevention warning system, an environmental sensor network, an information service for residents, a water and sewage monitoring system, a medical institution network, an educational institution network, a logistics base system, and an administrative procedure system in the city. For example, a signal control API, a traffic volume data API, an emergency contact API, a state of a traffic light, traffic congestion information, an automatic notification when an accident occurs, emergency vehicle priority control information, traffic regulation information when an event is held, and the like are automatically collected from the traffic control system, a supply and demand adjustment API, power monitoring data, a failure notification, power consumption, peak power demand, an operation status of a distributed power source, a power outage occurrence history, priority supply information to important infrastructure, and the like are automatically collected from the power supply system, an earthquake warning API, an evacuation instruction API, fire detection data, a disaster occurrence history, a tsunami warning, a landslide disaster warning, evacuation shelter opening information, resident safety information at the time of a disaster, and the like are automatically collected from the disaster prevention warning system, an atmospheric data API, noise data, temperature and humidity data, a PM2.5 concentration, anomaly detection information, a pollen scattering amount, an ultraviolet ray amount, river water level data, and the like are automatically collected from the environmental sensor network, an application notification API, an administrative procedure API, event information, resident attribute information, the number of users, an emergency bulletin distribution history, a questionnaire result, feedback information from residents, and the like are automatically collected from the information service for residents, water quality data, flow rate data, anomaly detection data, an emergency shutoff control API, water leakage detection information, a pump operation status, operation data of a water purification plant, load information of a sewage treatment plant, and the like are automatically collected from the water and sewage monitoring system, a patient information linkage API, emergency transport information, a medical device operation status, disaster medical system information, vaccine inventory information, an infectious disease occurrence status, remote medical care data, shift information of medical workers, and the like are automatically collected from the medical institution network, an attendance management API, remote class data, an emergency contact API, educational content distribution information, school event information, safety confirmation information of students, a guardian contact history, learning progress data, and the like are automatically collected from the educational institution network, a delivery status API, inventory data, delivery route information, an emergency delivery instruction, a drone delivery status, temperature and humidity management data of a warehouse, package tracking information, position information of a delivery vehicle, and the like are automatically collected from the logistics base system, and an application reception API, resident card issuance data, special procedure information at the time of a disaster, My Number linkage information, a tax processing status, a subsidy application status, congestion information of an administrative counter, electronic signature data, and the like are automatically collected from the administrative procedure system. Specifically, the information collection unit includes a preprocessing module configured to convert raw data in various formats asynchronously transmitted from each subsystem into a unified multidimensional tensor format. The preprocessing module normalizes received text data, numerical data, and time-series data, respectively. The preprocessing module combines the normalized data to generate, for example, a 256-dimensional feature vector. The information collection unit stores the generated feature vector in a distributed in-memory database together with a time stamp and a system identifier. The information collection unit executes semantic analysis using natural language processing technology in this data collection process. The information collection unit analyzes a specification and metadata of each API, and extracts a semantic relevance between data items. The information collection unit automatically constructs an ontology dictionary based on the extracted relevance. The information collection unit automatically maps the same concept having different names among different systems by referring to the ontology dictionary. The information collection unit handles, for example, the number of vehicles of the traffic control system and traffic of the environmental sensor network as the same variable. The information collection unit completely eliminates man-hours for manual setting required for data integration between systems by this automatic mapping. The information collection unit applies an anomaly detection algorithm to the collected data. The information collection unit compresses the input feature vector into a low-dimensional space using an autoencoder-type neural network. The information collection unit restores the compressed data to an original dimension. The information collection unit calculates a reconstruction error between the input vector and the restored vector. When the reconstruction error exceeds a preset threshold value, the information collection unit flags the data as an abnormal value. The information collection unit preferentially transfers data including the abnormal value to the subsequent linkage adjustment unit. The information collection unit enables early discovery of and rapid response to an abnormal situation in the urban infrastructure by this priority transfer. The information collection unit receives, as input data, for example, a one-dimensional numerical array indicating a traffic volume, a categorical variable indicating a state of a traffic light, and a multidimensional vector indicating weather information. The information collection unit combines these input data to generate a 1024-dimensional integrated state tensor. The information collection unit provides this integrated state tensor as an input to a subsequent AI model. The information collection unit enables a situation of the entire city to be handled as a single mathematical expression by generating this integrated state tensor. The information collection unit dramatically improves calculation efficiency in subsequent processing by using this mathematical expression.

The linkage adjustment unit automatically determines which systems are to be linked with each other through what path and method based on the detailed interface information and service quality requirement of each system aggregated from the information collection unit, and generates a linkage path. For example, the traffic control system and the disaster prevention warning system are linked to generate a linkage path for automatically controlling a traffic signal and securing an evacuation route when an earthquake occurs. The information service for residents and the disaster prevention warning system are linked to generate a linkage path for immediately distributing an evacuation instruction and disaster information to a smartphone and digital signage of a resident. The power supply system and the medical institution network are linked to generate a linkage path for automatically controlling priority power supply to an important medical institution at the time of a power outage. The environmental sensor network and the traffic control system are linked to generate a linkage path for limiting a traffic volume in a specific area when air pollution exceeds a reference value. The water and sewage monitoring system and the disaster prevention warning system are linked to generate a linkage path for automatically executing an emergency shutoff of a sewer in conjunction with a flood warning at the time of heavy rain. The logistics base system and the traffic control system are linked to generate a linkage path for automatically securing an emergency relief supply delivery route at the time of a disaster. The educational institution network and the information service for residents are linked to generate a linkage path for immediately distributing safety information of students to a guardian at the time of a disaster. The administrative procedure system and the information service for residents are linked to generate a linkage path for rapidly notifying a resident of special procedure information and a support measure at the time of a disaster. The traffic control system and the information service for residents are linked when an urban marathon is held to generate a linkage path for notifying a resident of traffic regulation information and a detour route in real time. The environmental sensor network and the medical institution network are linked when a heatstroke warning is issued in summer to generate a linkage path for strengthening an emergency transport system. The medical institution network and the educational institution network are linked when an infectious disease is prevalent to generate a linkage path for distributing school closure information and remote class information to students and guardians. Specifically, the linkage adjustment unit constructs a directed graph on a memory with all systems in the city as nodes and communicable paths between the systems as edges. The linkage adjustment unit allocates a multidimensional weight vector having a bandwidth, a delay, a packet loss rate, and a security level as elements to each edge. The linkage adjustment unit receives the integrated state tensor provided from the information collection unit as an input. The linkage adjustment unit infers an optimal linkage path for a current urban situation using a graph neural network. The graph neural network includes a plurality of message passing layers. The graph neural network exchanges a feature amount of each node with an adjacent node, and updates an embedding vector of the node. The linkage adjustment unit calculates a probability that an edge should be formed between arbitrary two nodes using the updated embedding vector of the node. The linkage adjustment unit specifies a node pair in which the calculated probability exceeds a threshold value. The linkage adjustment unit searches for an optimal physical and logical path connecting the specified node pair by a constrained shortest path algorithm obtained by extending Dijkstra's algorithm. The linkage adjustment unit determines the searched path as a linkage path. The linkage adjustment unit uses a reinforcement learning algorithm in combination in this linkage path generation processing. The linkage adjustment unit defines a degree to which the generated linkage path satisfies the service quality requirement as a reward. The linkage adjustment unit causes an agent to perform trial and error millions of times in a past simulation environment. The linkage adjustment unit optimizes a weight of a deep neural network approximating a Q-function through this learning process. The linkage adjustment unit instantaneously derives an optimal linkage path even under an unknown disaster situation by using the optimized model. The linkage adjustment unit receives, as input data, for example, an identifier of a start point node, an identifier of an end point node, a numerical value indicating a required maximum delay time, and a numerical value indicating a required minimum bandwidth. The linkage adjustment unit outputs, as output data, structured data including a list of intermediate nodes to be passed through, an identifier of a communication protocol to be applied in each section, and a specific value of a bandwidth to be allocated. The linkage adjustment unit transmits this output data to the subsequent protocol conversion unit and QoS control unit. The linkage adjustment unit completely automates a complex routing setting conventionally manually designed by a network administrator through this series of processing. The linkage adjustment unit shortens a time required for changing a network configuration from several days to several milliseconds by this automation. In the linkage adjustment unit, this improvement in processing speed brings about a technical effect of enhancing responsiveness to a dynamically changing urban environment.

The AI control unit flexibly and timely reconfigures the linkage path and the service quality setting generated by the linkage adjustment unit in accordance with a prompt input or an additional requirement using generative AI. For example, by causing the generative AI to read prompts such as “give top priority to linkage between the disaster prevention warning system and the traffic control system when a large-scale earthquake occurs, and make evacuation information distribution to the information service for residents immediate”, “give top priority to notification to the information service for residents when an air pollution warning is issued, and limit a traffic volume in a specific area in linkage with the traffic control system”, “strengthen linkage between the disaster prevention warning system and the information service for residents when a power failure occurs, and notify a power supply status to important infrastructure in real time”, “newly add the logistics base system to an emergency delivery network”, “notify local residents of emergency transport information of the medical institution network in linkage with the information service for residents”, “immediately distribute the emergency contact API of the educational institution network to guardians in linkage with the information service for residents”, “strengthen linkage between the traffic control system and the information service for residents when an urban marathon is held, and notify traffic regulation information in real time”, and “strengthen linkage between the environmental sensor network and the medical institution network when a heatstroke warning is issued, and strengthen an emergency transport system”, the AI automatically optimizes and reconfigures the linkage path and the service quality setting based on these instructions. Specifically, the AI control unit includes a large language model having billions of parameters as a core. The large language model adopts a transformer architecture. The large language model has a structure in which a plurality of self-attention mechanism layers are stacked. The AI control unit converts the input natural language prompt into a sequence of integers using a tokenizer. The AI control unit maps the sequence of integers to a word embedding vector in a high-dimensional space. The AI control unit adds positional encoding to the word embedding vector. The AI control unit inputs a vector sequence to which the positional encoding is added to the large language model. The large language model calculates a dependency relationship between respective elements of the input vector sequence. The large language model generates a hidden state vector in consideration of a context. The AI control unit converts the generated hidden state vector into a probability distribution of a control command via a fully connected layer and a softmax function. The AI control unit decodes a sequence of a control command having the highest likelihood from the probability distribution. The AI control unit receives, as input data, for example, a text character string of earthquake occurrence, highest priority, and linkage between traffic control and disaster prevention. The AI control unit outputs, as output data, structured data including a pair of system identifiers to be linked, a numerical value of a QoS class to be allocated, and an identifier of a security policy to be applied. The AI control unit inputs the output structured data to a parser. The parser verifies whether the structured data satisfies a constraint condition of the system. When the constraint condition is satisfied, the parser converts the data into an executable setting script. The AI control unit issues the generated setting script to a management interface of each network device. The AI control unit automatically translates an ambiguous human intention into a strict control command interpretable by a computer through this series of processing. The AI control unit refers to a past operation history and a system configuration diagram as an external knowledge base in this translation process. The AI control unit automatically complements a technical parameter lacking in the prompt using retrieval-augmented generation technology. The AI control unit enables even an operator without specialized knowledge to safely and accurately execute complex network control by this complement function. The AI control unit brings about a technical effect of dramatically reducing an operation mistake in an emergency by introducing this natural language interface.

When a communication protocol is different between different systems, the protocol conversion unit automatically executes various protocol conversion processes, such as converting the signal control API of the traffic control system into the evacuation instruction API of the disaster prevention warning system, converting the supply and demand adjustment API of the power supply system into the priority power supply API of the medical institution network, converting the atmospheric data API of the environmental sensor network into the traffic volume control API of the traffic control system, converting the water quality data API of the water and sewage monitoring system into the flood warning API of the disaster prevention warning system, and converting the delivery status API of the logistics base system into the emergency vehicle priority control API of the traffic control system. Specifically, the protocol conversion unit analyzes header information and a payload of a received packet using deep packet inspection technology. The protocol conversion unit specifies a data format of a transmission source system based on an analysis result. The protocol conversion unit temporarily converts the specified data format into a common data model inside the system. The protocol conversion unit reconverts the common data model into a data format required by a destination system. The protocol conversion unit executes a semantic mapping algorithm in this conversion process. The semantic mapping algorithm calculates a semantic similarity between a name of a transmission source data item and a name of a destination data item using a natural language processing model. The protocol conversion unit automatically links items having a similarity exceeding a predetermined threshold value. The protocol conversion unit maps, for example, latitude and longitude data of a transmission source to geolocation data of a destination. The protocol conversion unit also executes conversion of a data type at the same time. The protocol conversion unit converts, for example, a character string type time stamp into an integer type of UNIX epoch time. The protocol conversion unit receives, as input data, for example, signal state data of the traffic control system described in an Extensible Markup Language format. The protocol conversion unit outputs, as output data, a control command for the disaster prevention warning system described in a JSON format. The protocol conversion unit transmits this output data as an HTTP request to an API endpoint of the destination system. The protocol conversion unit executes this protocol conversion processing at wire speed using a dedicated hardware accelerator. The protocol conversion unit utilizes a packet processing pipeline mounted on a field-programmable gate array. The protocol conversion unit reduces a processing delay by an order of several digits by this hardware processing as compared with conversion processing by software. The protocol conversion unit enables seamless linkage between systems in a use case such as priority control of an emergency vehicle or instantaneous voltage drop protection of a power grid in which real-time performance is extremely important by this ultra-low delay processing. In the protocol conversion unit, ensuring interoperability under this heterogeneous environment brings about a technical effect of facilitating system integration of the entire city.

The QoS control unit executes allocation of a communication bandwidth, delay control, packet priority setting, automatic switching of a redundant path, traffic shaping, application of encrypted communication, automatic recovery when a failure occurs, and the like in accordance with a service quality requirement required for each linkage path. For example, fine QoS control is performed, such as maximizing a communication bandwidth between the disaster prevention warning system and the traffic control system when a disaster occurs and immediately distributing a notification to the information service for residents with a minimum delay, automatically applying a redundant path to a linkage path between the medical institution network and the power supply system, applying encrypted communication to communication between the environmental sensor network and the traffic control system, applying packet priority setting to communication between the logistics base system and the traffic control system, and applying traffic shaping to communication between the educational institution network and the information service for residents. Specifically, the QoS control unit separates and manages a data plane and a control plane of a network device using software-defined networking technology. The QoS control unit executes a deep reinforcement learning model in the control plane. The deep reinforcement learning model inputs a current traffic state of a network, a utilization rate of each link, and a length of a queue as a state space. The deep reinforcement learning model outputs an allocation amount of a bandwidth for each flow, weighting of a priority queue, and a change of a routing path as an action space. The QoS control unit calculates a reward function based on observation values of a delay time of a packet, a throughput, and a packet loss rate. The QoS control unit updates a weight of a neural network using a proximal policy optimization algorithm so as to maximize this reward. The QoS control unit receives, as input data, for example, a time-series array indicating the number of transmission and reception bytes for each port collected from each switch, and a numerical vector indicating a delay time of each flow. The QoS control unit outputs, as output data, a control rule set including a pair of a matching condition and an action to be written in a flow manual table of each switch. The QoS control unit distributes the output control rule set to each network switch via an OpenFlow protocol. The QoS control unit reallocates a bandwidth in milliseconds in response to a rapid increase in traffic by this dynamic rule update. The QoS control unit implements a token bucket algorithm at a hardware level in traffic shaping. The QoS control unit smoothes burst transfer of traffic with a low priority, and reliably protects a bandwidth of traffic with a high priority. The QoS control unit encrypts a payload of a packet using an Advanced Encryption Standard algorithm in application of encrypted communication. The QoS control unit minimizes an increase in communication delay by offloading encryption processing to a dedicated cryptographic coprocessor. The QoS control unit efficiently utilizes limited network resources to the utmost limit by such advanced traffic engineering. In the QoS control unit, this improvement in resource utilization efficiency brings about a technical effect of preventing network congestion and guaranteeing reliable arrival of mission-critical communication.

A site terminal linkage unit links with a terminal, a gateway device, an IoT device, a management PC, and the like installed in each system, and executes information collection at a site, protocol conversion, QoS control, a site optimization process by an AI agent, an immediate response at the time of a failure occurrence, reception of a prompt input from the site, and the like. For example, various site linkages are realized, such as a site terminal automatically switching to a backup path when a failure occurs in a traffic control system, an information service terminal for residents automatically adjusting bandwidth allocation when the number of users rapidly increases, an environmental sensor network terminal automatically recognizing an interface specification and reporting it to a server when a new sensor device is added, a site worker transmitting a prompt from a voice input or a tablet terminal to transmit a site requirement to an AI control unit, a site terminal at a logistics base automatically linking an emergency delivery instruction to the traffic control system, and a site terminal at a medical institution immediately notifying the information service for residents of emergency transport information. Specifically, the site terminal linkage unit adopts an edge computing architecture and distributes a load on a central server. The site terminal linkage unit deploys a lightweight inference engine in each site terminal. The inference engine executes a deep neural network whose model size is compressed by quantization and pruning techniques. The site terminal linkage unit locally executes a primary analysis on sensor data collected at the site terminal. The site terminal linkage unit transmits a feature vector thereof to the central server only when an abnormality is detected as a result of the primary analysis. The site terminal linkage unit significantly reduces consumption of a network bandwidth by this data filtering. The site terminal linkage unit executes federated learning at the site terminal. In the site terminal linkage unit, each site terminal updates a weight of a model using local data. The site terminal linkage unit transmits only a difference of the updated weight to the central server. The site terminal linkage unit aggregates the weight differences from the respective terminals in the central server and updates a global model. The site terminal linkage unit distributes the updated global model to each site terminal again. The site terminal linkage unit realizes highly accurate model learning using data of the entire city while protecting privacy by this distributed learning method. The site terminal linkage unit receives, as input data, for example, an image tensor acquired from a camera at the site or voice waveform data acquired from a microphone. The site terminal linkage unit outputs, as output data, a coordinate array of a bounding box indicating an object recognition result in an image or a text character string indicating a voice recognition result. The site terminal linkage unit transmits the output text character string as a prompt to the AI control unit of the central server. The site terminal linkage unit continues autonomous control using the local inference engine even when communication with the central server is interrupted. In the site terminal linkage unit, for example, a control terminal of a traffic signal falls back to a built-in rule-based engine at the time of a communication failure to maintain a safe signal cycle. The site terminal linkage unit prevents the entire system from going down due to a single point of failure by this autonomous distributed control. The site terminal linkage unit brings about a technical effect that this improvement in fault tolerance dramatically increases resilience of urban infrastructure.

A data accumulation unit accumulates interface information, a service quality requirement, a communication history, a failure occurrence history, traffic information, user behavior data, a prompt input history, an optimization result by AI, and the like collected from each system in chronological order, and realizes data-driven operation optimization such that the AI control unit learns a past failure occurrence pattern using these data to predict a future failure occurrence, analyzes the user behavior data to optimize bandwidth allocation at a peak time, analyzes the prompt input history to grasp a tendency of a site requirement and generate an automation rule, and accumulates the optimization result by the AI to reflect it in future decision making. For example, it contributes to advancement of city operation, such as analyzing a communication traffic history at the time of a past large-scale disaster to prepare an optimal bandwidth allocation and linkage path in advance at the time of a future disaster occurrence, analyzing feedback information of residents to optimize timing and content of information distribution, and analyzing a delivery history of a logistics base to automatically generate an emergency delivery route at the time of a disaster. Specifically, the data accumulation unit includes a distributed time-series database system capable of reading and writing petabyte-class data at high speed. The data accumulation unit writes the received data to a storage in a columnar format with a time stamp as a primary key. The data accumulation unit reduces a data size using a data compression algorithm when writing data. The data accumulation unit applies a prediction model using a long short-term memory network to the accumulated time-series data. The prediction model receives a transition of a traffic volume and an error rate for a certain past period as an input. The prediction model outputs a traffic volume and a failure occurrence probability at a specific future time step. The data accumulation unit receives, as input data, for example, a 1440-dimensional numerical vector indicating a packet loss rate per minute for the past 24 hours. The data accumulation unit outputs, as output data, a continuous value from 0 to 1 indicating a failure occurrence probability in the next one hour. The data accumulation unit transmits an alert instructing preventive resource allocation to the AI control unit when the output probability exceeds a predetermined threshold. The data accumulation unit applies latent Dirichlet allocation, which is a topic modeling algorithm, to the accumulated prompt input history. The data accumulation unit classifies an input tendency of an operator into a plurality of latent topics. The data accumulation unit generates a macro script for automating an operation related to a frequently appearing topic. The data accumulation unit shortens an execution time of a routine operation by registering the generated macro script in the system. The data accumulation unit continuously monitors a difference between the optimization result by the AI and actual system performance. The data accumulation unit automatically triggers a model re-learning process when the difference exceeds a certain allowable range. The data accumulation unit always keeps inference accuracy of an AI model up to date against secular changes in an urban environment and addition of a new system by this continuous learning loop. The data accumulation unit eliminates conventional manual tuning depending on a rule of thumb by this data-driven approach. The data accumulation unit brings about a technical effect that this optimization based on objective data maximizes operation efficiency of the entire system.

A user interface unit provides a GUI, a dashboard, a voice input interface, an application for a mobile terminal, and the like for a system administrator and a site worker to perform state monitoring of the system, a prompt input, confirmation and change of a linkage path and a QoS setting, a response instruction at the time of a failure occurrence, confirmation of an optimization proposal by AI, history reference of the data accumulation unit, and the like. For example, various user interfaces are realized, such as an administrator grasping a linkage status and a QoS setting of the entire city at a glance on a dashboard, a site worker inputting a prompt in a natural language from a tablet terminal, transmitting an immediate response instruction to the AI control unit by voice input when a failure occurs, the administrator approving or rejecting an optimization proposal by the AI, a resident changing a reception setting of information distribution from a smartphone application, and an administrative official immediately distributing special procedure information at the time of a disaster. Specifically, the user interface unit is implemented as a single-page application operating on a web browser. The user interface unit establishes a constant connection with the central server using a WebSocket protocol. The user interface unit push-distributes a state change event occurring on the server side to the client side with a delay in milliseconds. The user interface unit updates a virtual document object model based on the received event data. The user interface unit optimizes drawing performance by reflecting only a changed difference in actual screen drawing. The user interface unit visualizes a network topology of the entire city by a graph drawing algorithm using a dynamic model. The user interface unit dynamically changes a color and a thickness of each node and edge in accordance with a real-time traffic volume and error rate. The user interface unit executes a hybrid acoustic model combining a hidden Markov model and a deep neural network in the voice input interface. The user interface unit converts an input voice waveform into an acoustic feature vector such as a mel-frequency cepstrum coefficient. The user interface unit decodes the acoustic feature vector into a text character string. The user interface unit receives, as input data, for example, a voice waveform array with a sampling rate of 16 kilohertz. The user interface unit outputs, as output data, structured data including the recognized text character string and a reliability score of each word. The user interface unit displays a confirmation prompt on a screen to a user when the reliability score is less than a threshold. When displaying an optimization proposal by the AI, the user interface unit visualizes data and an inference process that are grounds for the proposal using explainable AI technology. The user interface unit presents, for example, a branch condition of a decision tree or an attention weight of a neural network as a heat map. The user interface unit improves reliability of a human operator with respect to a judgment of the AI, which tends to be a black box, by this visualization. The user interface unit brings about a technical effect that provision of this intuitive and highly responsive operation environment reduces a cognitive load on an operator in an emergency and supports quick and accurate decision making.

Specific examples of a prompt sentence to be read by generative AI necessary for carrying out the present invention include “give top priority to linkage between a disaster prevention warning system and a traffic control system when a large-scale earthquake occurs, and make evacuation information distribution to an information service for residents immediate”, “give top priority to notification to the information service for residents when an air pollution warning is issued, and limit a traffic volume in a specific area in linkage with the traffic control system”, “strengthen linkage between the disaster prevention warning system and the information service for residents when a power failure occurs, and notify a power supply status to important infrastructure in real time”, “add a new logistics base system to an emergency delivery network”, “notify local residents of emergency transport information of a medical institution network in linkage with the information service for residents”, “immediately distribute an emergency contact API of an educational institution network to guardians in linkage with the information service for residents”, “strengthen linkage between the traffic control system and the information service for residents when a city marathon is held, and notify traffic regulation information in real time”, and “strengthen linkage between an environmental sensor network and the medical institution network when a heatstroke warning is issued, and strengthen an emergency transport system”. Specifically, the system converts these prompt sentences in a natural language into a machine-readable intention expression through a natural language processing pipeline. The system executes morphological analysis and syntactic analysis on the input prompt sentence. The system extracts entities in the sentence and actions for them. The system maps the extracted entities and actions to blanks of a predefined command template using a slot filling technique. The system receives, as input data, for example, a character string “give top priority to linkage between a disaster prevention warning system and a traffic control system when a large-scale earthquake occurs, and make evacuation information distribution to an information service for residents immediate”. The system outputs, as output data, a structured control object in which a trigger condition is a large-scale earthquake, target systems are the disaster prevention warning system and the traffic control system, and an execution action is bandwidth maximization. The system converts this control object into an API call interpretable by a network controller. The system utilizes an in-context learning capability of a large language model in this conversion process. The system presents a past successful conversion example as a few-shot demonstration to the model together with the prompt sentence. The system strictly controls an output format of the model by this prompt engineering method, and brings an occurrence rate of a syntax error close to zero. The system executes a security check using a static analysis tool on the generated control object. The system blocks in advance a command that may cause an unintended system stop or privilege escalation. The system generates a deterministic and safe system control instruction from unstructured data, which is a natural language, by this series of processes. The system enables a domain expert having no programming knowledge to directly reflect his/her own expertise in system control by this non-conventional processing method. The system brings about a technical effect that this abstraction of an interface eliminates personalization of system operation and significantly reduces an operation cost.

### Implementation Steps

Step 1: Automatic Collection of Urban System Information

The information collection unit automatically collects interface information, a service quality requirement, a communication protocol, a bandwidth, a delay tolerance value, a redundant configuration, a failure occurrence history, the number of users, traffic information, a sensor data collection cycle, an external linkage API specification, an encryption method, a security authentication method, a transaction processing capability, a database configuration, traffic information at a peak time, a distribution data capacity, distribution timing, targeting information, an abnormality detection algorithm, a notification method, and the like from various network systems constituting a city, such as a traffic control system, a power supply system, a disaster prevention warning system, an environmental sensor network, an information service for residents, a water and sewage monitoring system, a medical institution network, an educational institution network, a logistics base system, and an administrative procedure system in the city, and aggregates them in the data accumulation unit on the server side. Specifically, in this step, the information collection unit executes asynchronous polling processing and event-driven subscription processing in parallel for each subsystem. The information collection unit receives lightweight sensor data published from millions of IoT devices via a broker using a message queuing telemetry transport protocol. At the same time, the information collection unit periodically calls an API based on a representational state transfer architecture to acquire static configuration information and a batch processing result of each system. The information collection unit temporarily buffers the received various data streams in an in-memory message queue. The information collection unit asynchronously reads data from the message queue and executes a data cleansing process. The information collection unit performs interpolation of a missing value, removal of an outlier, and synchronization of a time stamp. The information collection unit converts the cleansed data into a multidimensional tensor format common to the system. The information collection unit receives, as input data, for example, temperature data and traffic volume data acquired at different sampling rates. The information collection unit outputs, as output data, a feature matrix resampled and normalized on a common time base. The information collection unit persists this feature matrix in a distributed columnar database having high-speed write performance. The information collection unit dynamically scales out this data collection pipeline using a container orchestration tool. The information collection unit automatically adds a data processing node when traffic rapidly increases, and reduces the node when a load decreases. The information collection unit always maintains a delay in data collection on the order of milliseconds by this auto-scaling function. The information collection unit brings about a technical effect that establishment of this high-throughput and low-delay data collection infrastructure is directly linked to improvement of inference accuracy and securing of real-time property in subsequent AI processing.
Step 2: Automatic Analysis and Generation of Linkage Path and Service Quality Requirement

The linkage adjustment unit automatically determines which systems are to be linked with each other through what path and method based on the detailed interface information and service quality requirement of each system aggregated from the information collection unit, and generates a linkage path. For example, linkage paths according to various city operation scenes are comprehensively and automatically designed, such as signal control at the time of an earthquake occurrence by linkage between the traffic control system and the disaster prevention warning system, immediate distribution of an evacuation instruction by linkage between the information service for residents and the disaster prevention warning system, priority power supply at the time of a power outage by linkage between the power supply system and the medical institution network, and traffic volume limitation at the time of air pollution by linkage between the environmental sensor network and the traffic control system. Specifically, in this step, the linkage adjustment unit executes a solver of a constraint satisfaction problem with the collected multidimensional tensor data as an input. The linkage adjustment unit develops a graph structure on a memory with all systems in the city as nodes and physical and logical connections as edges. The linkage adjustment unit assigns a current bandwidth, delay, and security level as weights to each edge. The linkage adjustment unit formulates the required service quality requirement as a constraint condition. The linkage adjustment unit sets a constraint that, for example, a delay is 10 milliseconds or less and a bandwidth is 1 gigabit per second or more. The linkage adjustment unit calculates an optimal path that minimizes a load on the entire network while satisfying these constraints using mixed integer linear programming. The linkage adjustment unit uses an A-star search algorithm, which is a heuristic search algorithm, in combination in order to reduce calculation complexity. The linkage adjustment unit receives, as input data, for example, a start point node, an end point node, and a set of required QoS parameters. The linkage adjustment unit outputs, as output data, a routing table including a sequence of nodes to be passed through and a resource amount to be allocated to each link. The linkage adjustment unit speeds up this path calculation process by parallel processing using a multi-core CPU. The linkage adjustment unit schedules a processing order based on a priority of each request when a plurality of linkage requests occur simultaneously. The linkage adjustment unit processes, for example, a linkage request of the disaster prevention warning system related to human life with priority over a linkage request of normal environmental data collection. The linkage adjustment unit verifies validity of the generated linkage path in advance using an internal simulator. The linkage adjustment unit specifies a bottleneck where packet loss or congestion may occur based on a simulation result, and finely adjusts the path. The linkage adjustment unit instantaneously constructs a complex and highly efficient network topology that cannot be designed by human intuition by applying this advanced mathematical optimization method. The linkage adjustment unit brings about a technical effect that this automatic design capability dramatically increases adaptability to dynamic changes in urban infrastructure.
Step 3: Automatic Setting of Protocol Conversion and QoS Control

A protocol conversion unit automatically executes a protocol conversion process necessary between different systems based on the linkage path generated by the linkage adjustment unit, and a QoS control unit automatically sets bandwidth allocation, delay control, packet priority setting, automatic switching of a redundant path, traffic shaping, application of encrypted communication, automatic recovery at the time of a failure occurrence, and the like in accordance with a service quality requirement required for each linkage path. Specifically, in this step, the protocol conversion unit dynamically deploys a container image for protocol conversion to a virtual network function arranged in each node of the generated linkage path. The protocol conversion unit executes serialization and deserialization processing of a payload in the deployed container. The protocol conversion unit converts, for example, binary data into text data. The QoS control unit issues a setting command to a traffic control subsystem operating at a kernel level of an operating system. The QoS control unit logically divides a transmission queue of a network interface card using a hierarchical token bucket algorithm. The QoS control unit sets parameters of a guaranteed bandwidth and a maximum bandwidth for each divided queue. The QoS control unit marks a priority of a packet in the entire network by rewriting a value of a code point included in an IP header of the packet. The QoS control unit receives, as input data, for example, an identifier of a linkage path, a transmission source IP address, a destination IP address, and a numerical value of a required bandwidth. The QoS control unit outputs a low-level network control script as output data. The QoS control unit automatically executes this control script for each router and switch via a secure shell. The QoS control unit tests actual communication quality using an active measurement method after applying the setting. The QoS control unit transmits a test packet and measures a round trip time and jitter. The QoS control unit automatically readjusts a setting parameter through a feedback loop when a measurement result does not satisfy a requirement. The QoS control unit guarantees stable communication quality unaffected by a physical state change of the network by this closed-loop control. The QoS control unit brings about a technical effect that this fine-grained resource management by software definition maximizes utilization efficiency of the network and prevents service stoppage due to congestion.
Step 4: Dynamic Optimization and Reconfiguration by Generative AI

The AI control unit flexibly and timely reconfigures the linkage path and the service quality setting generated by the linkage adjustment unit in accordance with a prompt input or an additional requirement using generative AI. For example, by causing the generative AI to read prompts such as “give top priority to linkage between a disaster prevention warning system and a traffic control system when a large-scale earthquake occurs, and make evacuation information distribution to an information service for residents immediate”, “give top priority to notification to the information service for residents when an air pollution warning is issued, and limit a traffic volume in a specific area in linkage with the traffic control system”, “strengthen linkage between the disaster prevention warning system and the information service for residents when a power failure occurs, and notify a power supply status to important infrastructure in real time”, “add a new logistics base system to an emergency delivery network”, “notify local residents of emergency transport information of a medical institution network in linkage with the information service for residents”, and “immediately distribute an emergency contact API of an educational institution network to guardians in linkage with the information service for residents”, the AI automatically optimizes and reconfigures the linkage path and the service quality setting based on these instructions. Specifically, in this step, the AI control unit executes an inference pipeline of a large language model on a parallel computing cluster using a GPU. The AI control unit inputs the input prompt in a natural language to the model together with a state vector of the system. The AI control unit tokenizes text of the prompt and converts it into a high-dimensional embedding vector. The AI control unit calculates relevance between an important keyword in the prompt and a system state using an attention mechanism. The AI control unit generates a change procedure of a network configuration step by step based on this calculation result. The AI control unit receives, as input data, for example, text “earthquake occurrence, highest priority” and an adjacency matrix indicating a current network topology. The AI control unit outputs, as output data, structured patch data including a list of edges to be deleted, a list of edges to be added, and a QoS parameter to be updated. The AI control unit applies the output patch data to a network controller as a transaction. The AI control unit uses a two-phase commit protocol in an application process to guarantee atomicity of a setting change. The AI control unit automatically executes a rollback process to restore the system to a safe state when an error occurs during the setting change. The AI control unit completes this dynamic reconfiguration process on the order of several seconds to several tens of seconds. The AI control unit immediately adapts the system to a rapid environmental change such as at the time of a disaster occurrence by this high-speed reconfiguration. The AI control unit cross-checks the output configuration plan with a rule-based verification engine in order to prevent hallucination of the model. The AI control unit automatically discards a configuration plan violating a physical constraint or a security policy, and requests regeneration. The AI control unit achieves both flexibility and safety at a high level by a combination of this generative AI and strict verification logic. The AI control unit brings about a technical effect that this non-conventional processing method realizes autonomous and adaptive system operation exceeding a limit of manual setting by a human operator.
Step 5: Linkage With Site Terminal and Site Optimization Process

The site terminal linkage unit links with a terminal, a gateway device, an IoT device, a management PC, and the like installed in each system, and executes information collection at a site, protocol conversion, QoS control, a site optimization process by an AI agent, an immediate response at the time of a failure occurrence, reception of a prompt input from the site, and the like. For example, various site linkages are realized, such as a site terminal automatically switching to a backup path when a failure occurs in a traffic control system, an information service terminal for residents automatically adjusting bandwidth allocation when the number of users rapidly increases, an environmental sensor network terminal automatically recognizing an interface specification and reporting it to a server when a new sensor device is added, and a site worker transmitting a prompt from a voice input or a tablet terminal to transmit a site requirement to the AI control unit. Specifically, in this step, the site terminal linkage unit executes a software stack based on a microservice architecture on an edge device. The site terminal linkage unit activates a local AI agent deployed in each site terminal. The local AI agent processes raw data acquired from a sensor connected to the terminal in real time. The local AI agent executes, for example, a convolutional neural network that recognizes a license plate of a vehicle from a camera image. The site terminal linkage unit receives, as input data, for example, an image tensor with a resolution of 1920×1080. The site terminal linkage unit outputs, as output data, a vector including a recognized vehicle class, position coordinates, and a reliability score. The site terminal linkage unit determines an immediate control action at the site based on this inference result. The site terminal linkage unit transmits a control signal for automatically opening a gate, for example, when a specific vehicle is detected. The site terminal linkage unit constantly monitors quality of a communication link with the central server. The site terminal linkage unit autonomously switches a communication mode to a fallback mode when a packet loss rate exceeds a threshold. The site terminal linkage unit stops transmission of data with low importance in the fallback mode, and transmits only a critical alert via a backup line with a low bandwidth. The site terminal linkage unit executes a lightweight voice recognition model on the edge side when receiving a voice input from a site worker. The site terminal linkage unit inputs recognized text to an intention extraction model, and immediately executes a command if it is locally executable. The site terminal linkage unit transfers only a complex request requiring a judgment of the central server to the server. The site terminal linkage unit optimizes consumption of a network bandwidth while minimizing a response delay of the entire system by this cooperative processing of the edge and the cloud. The site terminal linkage unit brings about a technical effect that adoption of this distributed processing architecture eliminates a risk of a single point of failure and significantly improves robustness of urban infrastructure.
Step 6: Data Accumulation and AI Learning/Operation Optimization A data accumulation unit accumulates interface information, service quality requirements, communication histories, failure occurrence histories, traffic information, user behavior data, prompt input histories, optimization results by AI, and the like collected from each system in chronological order, and an AI control unit realizes data-driven operation optimization, such as learning past failure occurrence patterns using these data to predict future failure occurrences, analyzing the user behavior data to optimize bandwidth allocation at peak times, analyzing the prompt input histories to grasp trends in site requirements and generating an automation rule, and accumulating the optimization results by the AI to reflect them in future decision-making. Specifically, in this step, the data accumulation unit executes an offline batch learning process using the accumulated massive log data. The data accumulation unit constructs a supervised learning dataset in which a system state vector at the time of a past failure occurrence is a positive example and a state vector at a normal time is a negative example. The data accumulation unit trains a classification model based on a gradient boosting decision tree algorithm using this dataset. The data accumulation unit optimizes hyperparameters of the model using a cross-validation method to prevent overfitting. The data accumulation unit receives, as input data, a multidimensional vector including statistics of CPU usage, memory usage, and network traffic for the past week, for example. The data accumulation unit outputs, as output data, a score indicating a probability that each subsystem will cause a failure within the next 24 hours. The data accumulation unit deploys the trained model to an inference pipeline in a production environment. The data accumulation unit continuously fine-tunes weights of the model with data flowing in real time using an online learning method. The data accumulation unit updates parameters so as to minimize a prediction error using a stochastic gradient descent method. The data accumulation unit stores past optimization results in an experience replay buffer of a reinforcement learning agent. The data accumulation unit improves the accuracy of a policy function by causing the agent to repeatedly learn past success experiences and failure experiences. The data accumulation unit applies a natural language processing technology to the prompt input histories to extract a co-occurrence network of frequently appearing words. The data accumulation unit automatically discovers potential needs of an operator and operational issues of the system from the extracted network. The data accumulation unit generates a new automation script and a monitoring rule based on this discovered knowledge. The data accumulation unit brings about a technical effect that the system autonomously evolves and operational efficiency improves over time by this data-driven continuous improvement cycle.

### Specific Use Case

For example, when a large-scale earthquake occurs in a city, the system of the present invention first automatically collects earthquake occurrence information and evacuation instruction data from a disaster prevention warning system, simultaneously acquires a signal control API, emergency vehicle priority control information, and traffic congestion information from a traffic control system, and further acquires an application notification API, resident attribute information, and an emergency bulletin distribution history from an information service for residents. Based on these pieces of information, a linkage adjustment unit generates an emergency signal control linkage path between the disaster prevention warning system and the traffic control system, and automates securing of an evacuation route and priority passage of an emergency vehicle. In addition, an immediate evacuation instruction distribution linkage path is generated between the disaster prevention warning system and the information service for residents, and evacuation information is distributed in real time to smartphones and digital signage of residents. Furthermore, power outage occurrence information and priority power supply information to important infrastructure are acquired from a power supply system, and a path for automatically controlling power supply to an important medical institution at the time of a power outage is generated in linkage with a medical institution network. Secondary disaster risks (for example, gas leak and fire detection data) due to the earthquake are acquired from an environmental sensor network, and additional warnings and evacuation instructions are distributed in linkage with the disaster prevention warning system and the information service for residents as necessary. A protocol conversion unit automatically realizes data linkage between different systems by converting the evacuation instruction API of the disaster prevention warning system into the signal control API of the traffic control system and also converting it into the application notification API of the information service for residents. A QoS control unit ensures certainty and immediacy of information transmission by maximizing a communication bandwidth, minimizing a delay, and automatically applying a redundant route to the linkage path at the time of a disaster. A site terminal linkage unit links with a traffic signal control terminal, an evacuation center management terminal, a power monitoring terminal of a medical institution, and the like at a site, and accepts an immediate response at the site and a prompt input from the site. A data accumulation unit accumulates all communication histories, failure occurrence histories, evacuation behavior data of residents, prompt input histories from the site, and the like at the time of the earthquake occurrence in chronological order, and an AI control unit learns these data to prepare an optimal linkage path and bandwidth allocation at the time of a future disaster in advance. A user interface unit enables an administrator to grasp a linkage status and a QoS setting of the entire city at a glance on a dashboard, and to input an additional prompt to the AI control unit as necessary. Specifically, in this use case of the large-scale earthquake, the system operates a complex event processing engine based on an event-driven architecture. The system analyzes data of initial tremors transmitted from a seismometer in units of milliseconds. The system receives, as input data, a time-series waveform tensor obtained from a 3-axis acceleration sensor, for example. The system outputs, as output data, structured data including an estimated epicenter, a magnitude, and an estimated arrival time to each region. Using this output data as a trigger, the system immediately executes an emergency response workflow compiled in a memory in advance. The system multicasts a control command for switching all traffic lights to red to the traffic control system. At the same time, the system tracks GPS coordinates of the emergency vehicle in real time. The system executes a dynamic routing algorithm for switching only a traffic light in a traveling direction of the emergency vehicle to green. In the power supply system, the system analyzes power consumption data of each household collected from a smart meter. The system specifies a power outage area as polygon data. The system collates the specified polygon data with position coordinates of the medical institution by a spatial operation. The system specifies an important medical institution existing in the power outage area, and automatically generates a power accommodation route from a nearby distributed power source or storage battery by a graph search algorithm. In the protocol conversion unit, the system converts a message of the disaster prevention warning system into a control packet in a binary format interpretable by the traffic control system at wire speed. In the QoS control unit, the system adds a tag for emergency communication to the packet, and routes the packet to an absolute priority queue of a network switch. The system completes this series of processing within a few seconds from the occurrence of the earthquake without intervention of a human operator. By this extreme real-time processing, the system brings about a direct technical effect of minimizing the spread of damage and maximizing the efficiency of lifesaving. As post-processing, the system analyzes the accumulated tracking data of evacuation behavior by a clustering algorithm. The system specifies a bottleneck of an actual evacuation route, and uses it for automatic updating of a next disaster response plan.

Specific examples of prompt sentences to be read by the generative AI include “Give top priority to linkage between the disaster prevention warning system and the traffic control system when a large-scale earthquake occurs, and make evacuation information distribution to the information service for residents immediate”, “Strengthen linkage between the medical institution network and the power supply system when a power outage occurs, and notify a power supply status to an important medical institution in real time”, “Strengthen linkage between the disaster prevention warning system and the information service for residents when the environmental sensor network detects a fire, and distribute an immediate warning to residents in a corresponding area”, “Strengthen linkage between the information service for residents and an administrative procedure system when an evacuation center is opened, and distribute evacuation center information and special procedure guidance to residents”, and “Strengthen linkage between the traffic control system and a logistics base system when traffic congestion occurs, and automatically reconfigure an emergency delivery route”. Specifically, the system uses a fine-tuned domain-specific large language model to process these prompt sentences. The system divides the input prompt sentence into subword tokens using a byte-pair encoding algorithm. The system embeds the divided token sequence into a continuous vector space of 4096 dimensions, for example. In an encoder layer of a transformer, the system extracts a contextual dependency relationship between tokens using a multi-head attention mechanism. The system receives, as input data, a text such as “Strengthen linkage between the traffic control system and the logistics base system when traffic congestion occurs, and automatically reconfigure an emergency delivery route”, for example. The system outputs, as output data, a structured abstract syntax tree including a URL of an API endpoint to be executed, an HTTP method, and a payload. The system traverses this abstract syntax tree and generates a specific network control command corresponding to each node. The system compiles the generated command group into an execution plan expressed as a directed acyclic graph. The system executes each task of the execution plan in parallel while satisfying a dependency relationship. In this prompt analysis process, the system continuously improves the model by applying a reinforcement learning from human feedback method. When an operator corrects the generated control command, the system feeds back the correction content to the model as a reward signal. By this feedback loop, the system enables the model to learn operation rules and tacit knowledge peculiar to a city. The system brings about a technical effect that the provision of this highly abstracted interface by natural language eliminates human errors and dramatically improves operational efficiency in system management of a smart city that is becoming complex. By this non-conventional processing method, the system enables a flexible and rapid response even to an unknown complex disaster that cannot be handled by a conventional fixed rule-based system.

The specific processing unit 290 sends the results of specific processing obtained in Example 1 or Application Example 1 described above to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence).

An example of the data generation model 58 is a generative AI such as ChatGPT (registered trademark) (Internet search <URL: https://openai.com/blog/chatgpt>).

The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart device 14.

### Second Embodiment

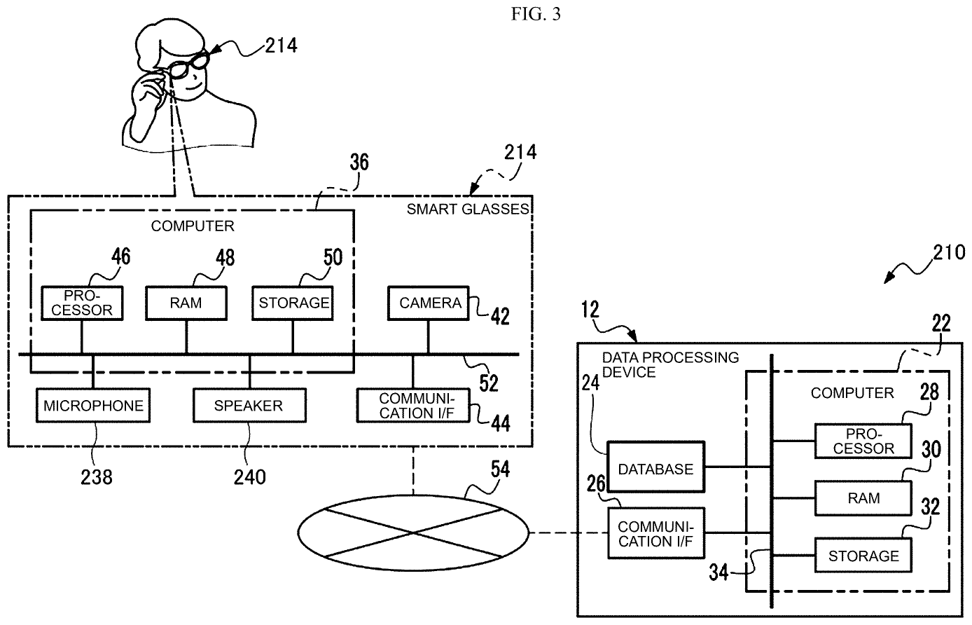

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, camera 42, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

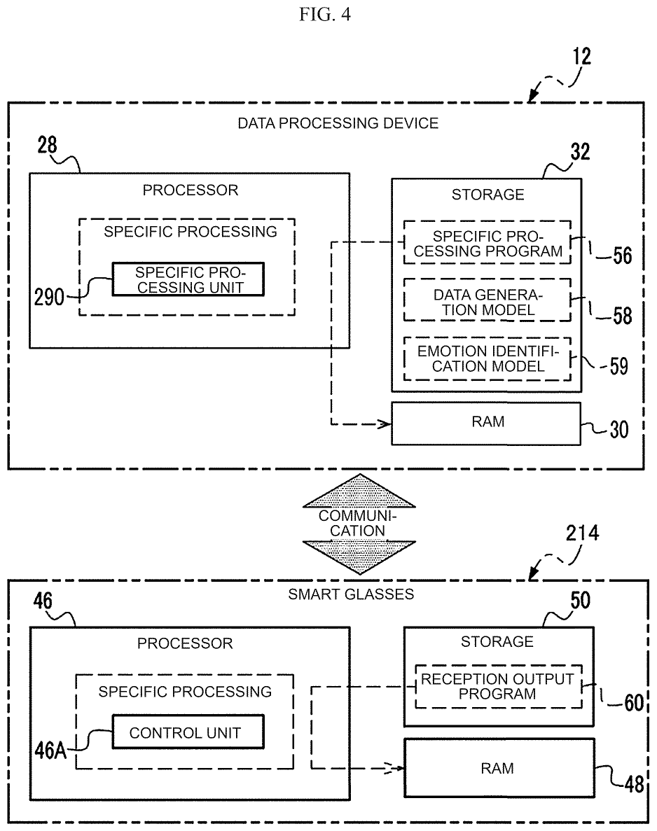

FIG. 4 shows an example of the main functions of the data processing device 12 and smart glasses 214. As shown in FIG. 4, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart glasses 214, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48. The smart glasses 214 may also have similar data generation models and emotion identification models as the data generation model 58 and emotion identification model 59, and perform the same processing as the specific processing unit 290 using these models.

Next, specific processing by the specific processing unit 290 of the data processing device 12 will be described. Each part of the system described below is realized by the data processing device 12 and the smart glasses 214. In the following description, the data processing device 12 is referred to as a “server,” and the smart glasses 214 are referred to as a “terminal.”

### Example 1

Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart glasses 214.

### Third Embodiment

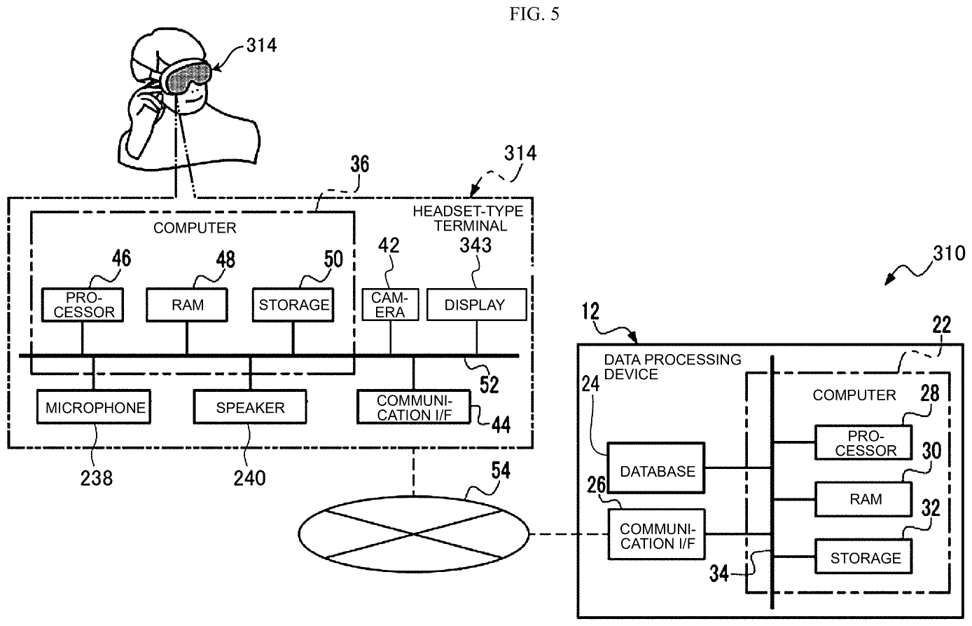

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, display 343, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

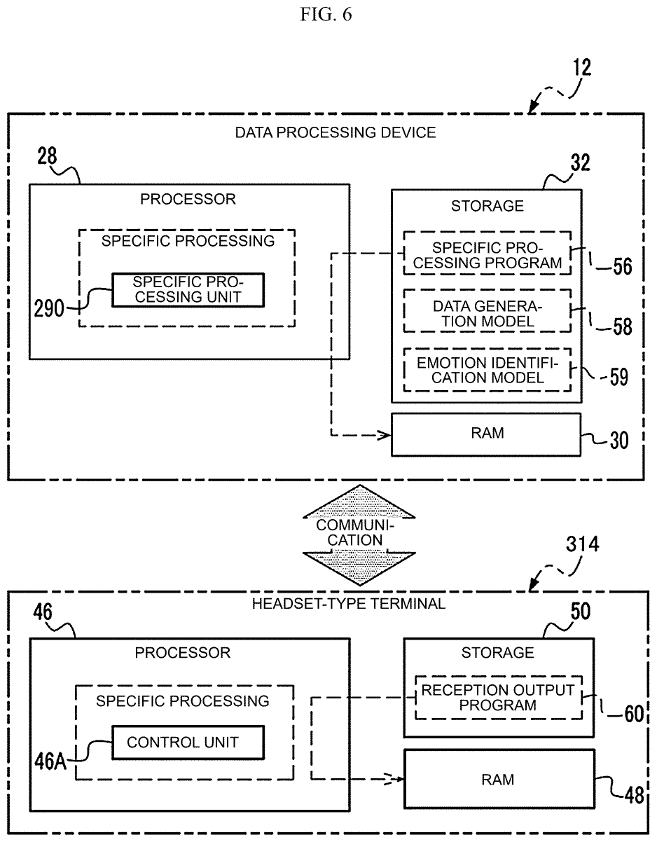

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the headset-type terminal 314, reception output processing is performed by the processor 46.

The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the headset-type terminal 314. In the following description, the data processing device 12 is referred to as a “server,” and the headset-type terminal 314 is referred to as a “terminal.”

(Example 1) Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

In the above embodiments, an example form where specific processing is performed by the data processing device 12 was described, but the technology disclosed herein is not limited to this, and specific processing may be performed by the headset-type terminal 314.

### Fourth Embodiment

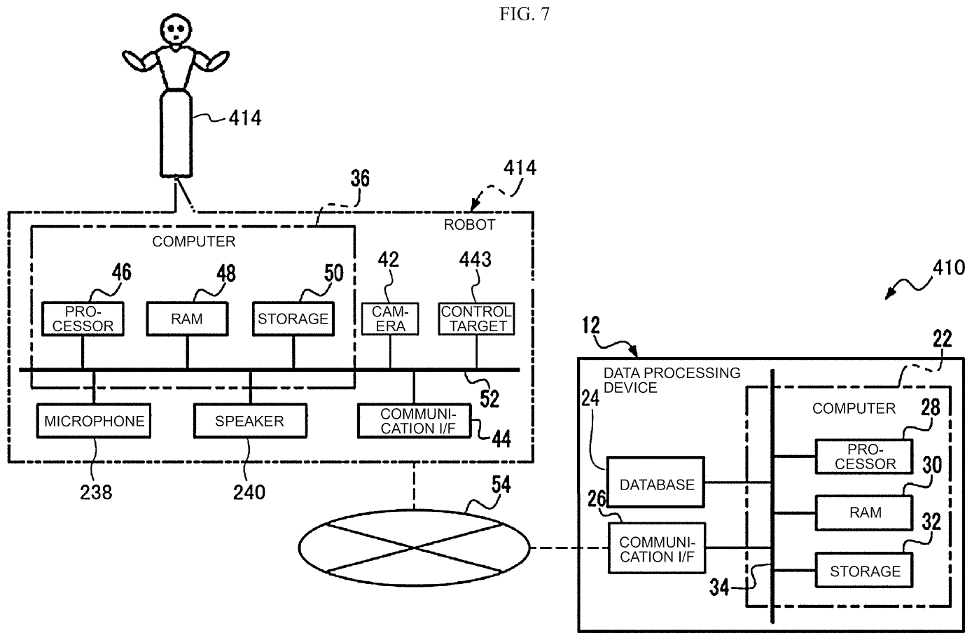

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, control target 443, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

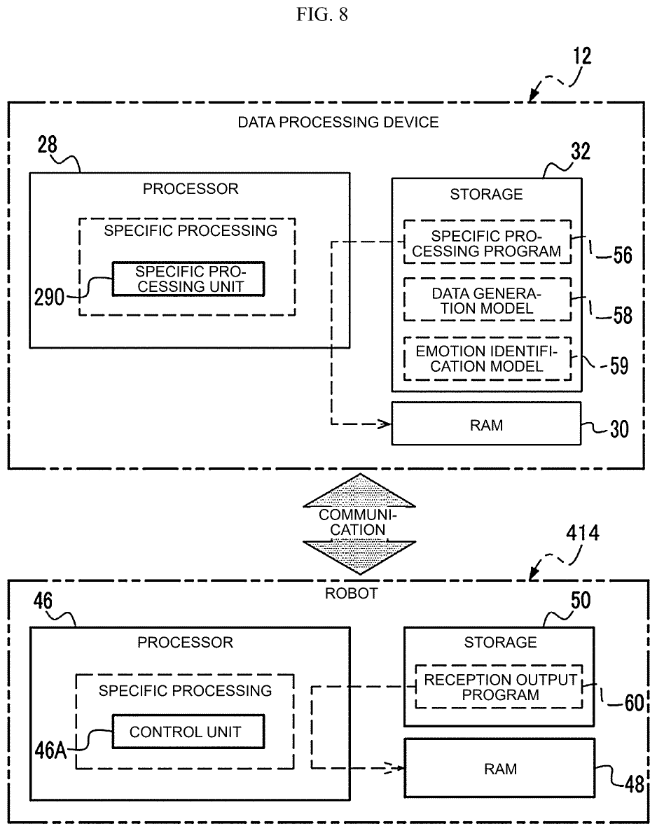

FIG. 8 shows an example of the main functions of the data processing device 12 and the robot 414. As shown in FIG. 8, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the robot 414, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the robot 414. In the following description, the data processing device 12 is referred to as a “server,” and the robot 414 is referred to as a “terminal.”

(Example 1) Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

In the above embodiments, an example form where specific processing is performed by the data processing device 12 was described, but the technology disclosed herein is not limited to this, and specific processing may be performed by the robot 414.

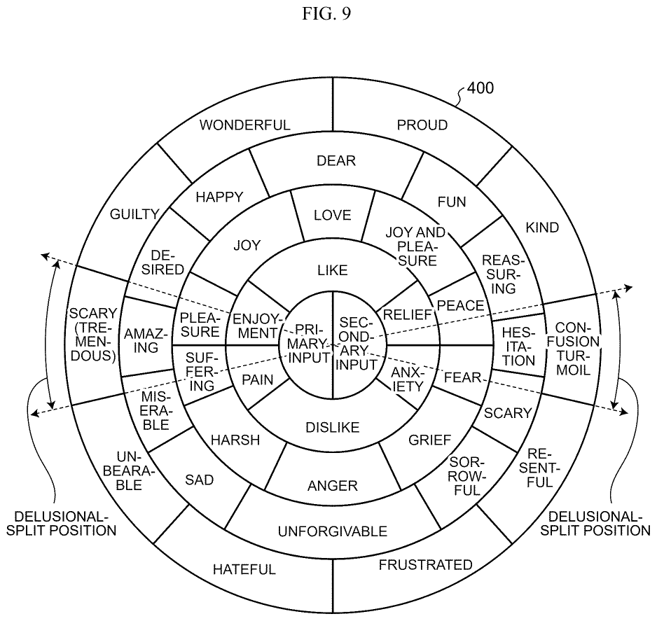

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

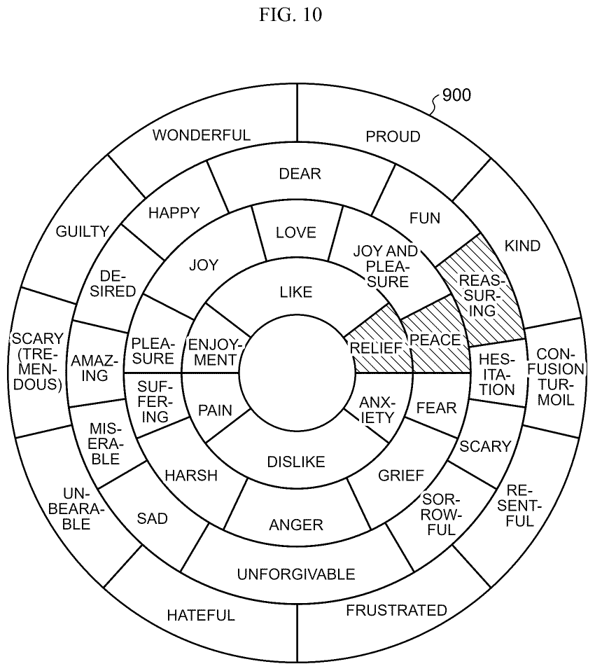

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above, the system according to the present disclosure has been described mainly on the functions of the data processing device 12, but the system according to the present disclosure is not necessarily mounted on a server. The system according to the present disclosure may be implemented as a general information processing system. The present disclosure may be implemented, for example, as a software program running on a personal computer, or an application running on a smartphone or the like. The method according to the present disclosure may be provided to the user in the form of SaaS (Software as a Service).

In the above embodiments, an example form where specific processing is performed by a single computer 22 was described, but the technology disclosed herein is not limited to this, and distributed processing for specific processing by multiple computers including the computer 22 may be performed. For example, the data generation model 58 may be provided in an external device of the data processing device 12, and the external device may generate data corresponding to the input data.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned.

Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

Note that the following supplementary notes are further disclosed regarding the above description.

### Supplementary Note 1

A system for integrally linking and optimizing a plurality of independent systems constituting urban infrastructure and resident services, the system comprising: an information collection unit configured to automatically collect interface information and a service quality requirement of each system; a linkage adjustment unit configured to automatically generate a linkage path between the respective systems based on the collected interface information and service quality requirement, and determine an optimal service quality setting for each linkage path; and an AI control unit configured to flexibly and timely reconfigure the linkage path and the service quality setting in accordance with a prompt input or an additional requirement using generative AI, and automatically realize linkage between the respective systems, wherein the AI control unit comprehensively determines a physical or logical connection state of various systems constituting a city, such as an urban operation status, an emergency response at the time of a disaster occurrence, optimization of resident services, energy management, traffic control, environmental monitoring, a disaster prevention warning, an administrative service, a medical network, an educational network, and a logistics network, a service quality requirement according to a usage scene, and a linkage requirement between the systems, and centrally and automatically realizes, by software, an adjustment operation conventionally performed manually or by adding hardware.

### Supplementary Note 2

The system according to Supplementary Note 1, wherein the information collection unit is configured to monitor the interface information and the service quality requirement of each system in real time, the linkage adjustment unit is configured to dynamically optimize the linkage path and the service quality setting between the systems based on a monitoring result, and the AI control unit is configured to enable a linkage configuration and the service quality setting to be immediately changed in accordance with a natural language prompt input using the generative AI.

### Supplementary Note 3

The system according to Supplementary Note 1, wherein the AI control unit is configured to learn an interface specification and the service quality requirement of each system, the linkage adjustment unit is configured to automatically determine an optimal linkage path and an optimal service quality setting among the plurality of systems based on an inference result by the generative AI, and furthermore, even when a new system is added or a configuration of an existing system is changed, the AI control unit is configured to autonomously reconfigure the linkage path and the service quality setting.

What is claimed is:

1. A system comprising:
circuitry configured to:
receive, via a communication interface coupled to a packet-switched network, data streams from a plurality of heterogeneous network systems, each data stream comprising a payload and metadata indicating a source identifier, a data type identifier, and an urgency level parameter, and store the data streams in a storage device;
apply a stream processing engine to extract the metadata from each received data stream in real time, convert the extracted metadata into a multidimensional tensor, and input the multidimensional tensor to a generative neural network model to determine an optimal routing destination identifier and a required data conversion operation for each data stream;
collect interface parameter records and service quality requirement records from each network system via the communication interface, and apply the generative neural network model to the interface parameter records and service quality requirement records to generate a linkage path configuration comprising connection path parameters and service quality setting parameters for each inter-system communication path;
apply the data conversion operation to each data stream and route the converted data stream to the determined routing destination identifier via the communication interface; and
reconfigure the linkage path configuration in response to prompt data received from a terminal device via the communication interface by applying the generative neural network model to the prompt data and the current linkage path configuration to generate an updated linkage path configuration.

2. The system according to claim 1, wherein the circuitry is configured to
adopt a publish-subscribe messaging model as an intermediary between the plurality of heterogeneous network systems, maintain a subscription registry mapping source identifiers to destination topic identifiers, and route each incoming data stream to subscribed destination systems based on the source identifier and data type identifier extracted from the metadata.

3. The system according to claim 2, wherein the circuitry is configured to
apply an in-memory stream processing engine to analyze the payload of each received data stream in real time, extract feature values from the payload comprising numerical measurement values, categorical state identifiers, and timestamp values, and convert the extracted feature values into the multidimensional tensor prior to input to the generative neural network model.

4. The system according to claim 1, wherein the circuitry is configured to
monitor service quality metrics for each communication path in the linkage path configuration by measuring latency values, packet loss rates, and bandwidth utilization rates, and generate a service quality deviation signal when any measured metric exceeds a corresponding service quality threshold parameter derived from the service quality requirement records.

5. The system according to claim 4, wherein the circuitry is configured to
apply the generative neural network model to the service quality deviation signal and the current linkage path configuration to generate a reconfiguration command comprising updated connection path parameters and updated service quality setting parameters, and transmit the reconfiguration command to the affected network systems via the communication interface.

6. The system according to claim 4, wherein the circuitry is configured to
detect a failure event in a network system by receiving a null data stream or an error status code from the corresponding source identifier, and instantaneously generate an alternative routing path by applying the generative neural network model to the current linkage path configuration with the failed source identifier marked as unavailable, and activate the alternative routing path within a failover latency threshold.

7. The system according to claim 1, wherein the circuitry is configured to
collect interface parameter records from each network system comprising protocol identifier data, bandwidth capacity values, delay tolerance values, redundancy configuration parameters, and security authentication method identifiers, and store the interface parameter records in an interface registry data structure in the storage device.

8. The system according to claim 7, wherein the circuitry is configured to
apply the generative neural network model to the interface registry data structure to identify protocol incompatibilities between interconnected network systems, generate protocol translation transformation rules for each identified incompatibility, and apply the corresponding transformation rules as the data conversion operation for data streams crossing incompatible system boundaries.

9. The system according to claim 1, wherein the circuitry is configured to
receive natural language prompt data from a terminal device via the communication interface describing a requested linkage configuration change, apply the generative neural network model to the natural language prompt data to extract structured configuration parameters, validate the extracted configuration parameters against interface parameter records and service quality requirement records, and generate an updated linkage path configuration from the validated configuration parameters.

10. The system according to claim 9, wherein the circuitry is configured to
transmit a structured configuration preview data record comprising the proposed updated linkage path configuration to the terminal device prior to activation, receive a confirmation response from the terminal device, and activate the updated linkage path configuration only after receiving a confirmation response associated with an authorized administrator user identifier.

11. The system according to claim 1, wherein the circuitry is configured to
apply an anomaly detection model to incoming data streams by computing a reconstruction error between each received data stream payload and an expected payload distribution model trained on historical data streams, and generate an anomaly routing signal when a reconstruction error exceeds an anomaly threshold parameter for a given source identifier.

12. The system according to claim 11, wherein the circuitry is configured to
apply the generative neural network model to the anomaly routing signal and the current linkage path configuration to generate a quarantine routing command directing the anomalous data stream to an isolated processing endpoint, and transmit an anomaly alert notification to a terminal device associated with an administrative user identifier via the communication interface.

13. The system according to claim 1, wherein the circuitry is configured to
update the generative neural network model used for routing destination determination by generating training pairs from historical data stream metadata tensors and corresponding validated routing destination identifiers, and fine-tune the generative neural network model on the training pairs to improve routing accuracy for novel data stream patterns.

14. The system according to claim 1, wherein the circuitry is configured to
store routing decision records comprising the multidimensional tensor, the determined routing destination identifier, and the data conversion operation in an audit log data structure with timestamps, and generate a routing pattern analysis report by aggregating routing decision records over a time window to identify high-frequency source-destination pairs and anomalous routing patterns.

15. The system according to claim 1, wherein the circuitry is configured to
distribute incoming data streams to a plurality of stream processing nodes via a load balancer, assign each data stream to an available processing node based on urgency level parameter values, and prioritize processing of data streams having urgency level parameter values exceeding an urgency threshold over data streams with lower urgency level parameter values.

16. The system according to claim 1, wherein the circuitry is configured to
encrypt data streams traversing inter-system communication paths using a transport layer security protocol, and apply a security authentication method identifier specified in the interface parameter record of each network system to authenticate data stream sources prior to routing.

17. The system according to claim 1, wherein the plurality of heterogeneous network systems comprise infrastructure monitoring systems, environmental sensor networks, and administrative data service systems, and the linkage path configuration manages communication paths and service quality parameters for inter-system data exchange.

18. A system comprising:
circuitry configured to:
receive, via a communication interface coupled to a packet-switched network, data streams from a plurality of heterogeneous network systems each comprising a payload and metadata including a source identifier, data type identifier, and urgency level parameter;
apply an in-memory stream processing engine to extract metadata and convert it into a multidimensional tensor, and input the multidimensional tensor to a generative neural network model to determine an optimal routing destination identifier and required data conversion operation for each data stream;
collect interface parameter records and service quality requirement records from each network system, and generate a linkage path configuration comprising connection path parameters and service quality setting parameters;
monitor service quality metrics for each communication path, detect failure events, and generate reconfiguration commands or alternative routing paths by applying the generative neural network model to the current linkage path configuration; and
reconfigure the linkage path configuration in response to natural language prompt data received from a terminal device by applying the generative neural network model to extract and validate structured configuration parameters.

19. The system according to claim 18, wherein the circuitry is configured to
apply an anomaly detection model to incoming data streams by computing reconstruction error scores against expected payload distributions, generate quarantine routing commands directing anomalous data streams to isolated processing endpoints, and transmit anomaly alert notifications to terminal devices associated with administrative user identifiers.

20. A method comprising:
receiving, via a communication interface coupled to a packet-switched network, data streams from a plurality of heterogeneous network systems, each data stream comprising a payload and metadata indicating a source identifier, a data type identifier, and an urgency level parameter, and storing the data streams in a storage device;
applying a stream processing engine to extract the metadata from each received data stream in real time, converting the extracted metadata into a multidimensional tensor, and inputting the multidimensional tensor to a generative neural network model to determine an optimal routing destination identifier and a required data conversion operation for each data stream;
collecting interface parameter records and service quality requirement records from each network system via the communication interface, and applying the generative neural network model to generate a linkage path configuration comprising connection path parameters and service quality setting parameters;
applying the data conversion operation to each data stream and routing the converted data stream to the determined routing destination identifier via the communication interface; and
reconfiguring the linkage path configuration in response to prompt data received from a terminal device by applying the generative neural network model to generate an updated linkage path configuration.
